(19) United States
(12) Patent Application Publication
(10) Pub. No.: US 2024/0074428 A1
(43) Pub. Date: Mar. 7, 2024

(54) SYSTEM AND METHOD FOR ADJUSTABLE TARGETING IN FIELD TREATMENT

(71) Applicant: PRECISION AI INC., Saskatoon (CA)

(72) Inventor: Daniel MCCANN, Regina (CA)

(21) Appl. No.: 18/467,124

(22) Filed: Sep. 14, 2023

Related U.S. Application Data
(63) Continuation of application No. PCT/CA2022/050309, filed on Mar. 3, 2022.
(60) Provisional application No. 63/229,406, filed on Aug. 4, 2021.
(60) Provisional application No. 63/162,938, filed on Mar. 18, 2021.

(51) Int. Cl. A01M 21/04; A01B 79/00; A01B 79/02; B64D 1/18; G06V 20/10; G06V 20/17; H04N 23/23; B64U 20/70

(52) U.S. Cl. CPC A01M 21/043; A01B 79/005; A01B 79/02; B64D 1/18; G06V 20/188; G06V 20/17; H04N 23/23; B64U 20/70; B64U 2101/30

(57) ABSTRACT

A method and system for field treatment. The method comprising a data collection unit for collecting data on a portion of a field; an interface for receiving a first parameter to be considered for treatment of said portion of said field and a first probability score threshold for said parameter; a calculation unit for calculating a first probability score of said first parameter in said data collected; and, a treatment unit for treating said portion of the field based on said first probability score for said first parameter and said first threshold.

The present application is a continuation patent application of PCT/C A2022/050309 filed on Mar. 03, 2022, designating the United States, that claims priority from U.S. provisional patent application No. 63/162,938 filed on Mar. 18, 2021, and U.S. provisional patent application No, 63/229,406 filed on Aug. 04, 2021, specifications of which are incorporated herein by reference.

### FIELD

This invention is in the area of field treatment identification and prioritization, and more specifically to systems and methods of pest identification and prioritization for agricultural and/or pest control applications, such as on farms, golf courses, parks, and/or along roadways, power lines, railroads, etc.

### BACKGROUND

Generally, a current farm management with a crop process 100 may be shown in FIG. 1. The farmer or agrologist may survey a field for a variety of weeds, fungi, or insects 102 (collectively known herein as “pests”). A pesticide, such as a herbicide., a fungicide, or an insecticide, and/or a mixture thereof, may be selected 104 and purchased from a pesticide dealer. An appropriate application time may be determined 106 and when the application time is reached, the pesticide may be broadly , applied to the field. The term pesticide may include all of the following: herbicide, insecticides (which may include insect growth regulators, termiticides, etc.), nematicide, molluscicide, pesticide, avicide, rodenticide, bactericide, in sect repellent, animal repellent, antimicrobial, fungicide, and any combination thereof.

In some instances, the appropriate application time may be a balance between a number of pests, an expense for applying the pesticide, and potential damage to the crop. If the application of the pesticide is too late, the pests may be done significant damage to the crop. If the application of the pesticide is too early then a second application may be required later in the season resulting in additional costs. Also, broad application of pesticides may be wasteful as the application of the pesticide maybe to areas of the field that do not have the pests.

Benefits of the aspects described herein may address disadvantages of the current farm management with the crop process. Other advantages may be apparent to a person of skill in the art upon understanding the aspects as described herein.

### SUMMARY

The aspects as described herein in any and/or all combinations consistent with the

understanding of one skilled in the art on review of the present application are disclosed.

In one broad aspect, the present disclosure provides a field treatment system which may comprise a vehicle having a data collection unit for collecting data on a portion and/or the entirety of a field; an interface for receiving a first parameter to be considered for treatment of the portion of the field and a first probability score threshold for the parameter; a calculation unit for calculating a first probability score of the first parameter in the data collected, and a treatment unit for treating the portion of the field based on the first probability score for the first parameter and the first threshold. In one example, if the first probability threshold is met or not met, depending on the setting of the system, the treatment of the field would be performed.

It would be appreciated by those skilled in the art that the vehicle could be any type of

vehicle known in the art including an unmanned aerial vehicle (UAV), a ground sprayer, an unmanned ground robot, or a manned aerial vehicle and any combination of thereof. Furthermore, it would be appreciated by those skilled in the art that one or more of such vehicles may work synchronistic or independently to collect the data regarding the field. Also, the size of the portion of the field for which data is collected may be set during operation or at the factory.

In some embodiments, the system may further include a vegetation detection module for detecting vegetation in the field. In one example, the vegetation detection module may implement hue, saturation, value (HSV) color index method to detect the vegetation. In one other example, the system may implement excess green method to detect the vegetation.

In some embodiments, the vegetation detection module may include a sensor for

detecting vegetation. In some examples, the sensor may be one or more of a lidar, a chlorophyll detection sensor, an infrared sensor, a near-infrared sensor or any other sensor capable of detecting vegetation.

It would be appreciated by those skilled in the art that other vegetation detection methods may be equally applied using a machine learning/AI engine. In one example the vegetation detection may be performed using the same AI platform used in other steps of the process, as disclosed herein, before calculating the probabilities for each parameter related to the field and/or the vegetation on the field. Similarly, a separate AI module may be implemented for the purposes of preliminary vegetation detection.

It would be appreciated by those skilled in the art that color of the vegetation may affect the vegetation detection method which would be used by the system. In some examples of the system, the interface may receive a second parameter related to the field along with a second probability score threshold. The calculation module may calculate a second probability score of the second parameter in the data collected. In such examples, the treatment unit treats the portion of the field based on the first and the second probability score and the first and second thresholds.

It would be appreciated by those skilled in the art that different combination of parameters may be used to decide whether to treat the field. For example, in on setting, the system may treat the field if all thresholds are met while in another setting, the system may treat the field only if threshold for parameter A is met and threshold for parameter B is not met. It would be appreciated by those skilled in the art than more than two parameters, and their related thresholds, may be considered by the system to determine whether to treat the field. The system may consider any parameter related to the field such as the crops and other vegetations present (type, stage, location, or vitality of the plant), the soil, the presence of pests and any other factor as decided by user. In one example, the first and second parameters may be related to the plant such as plant type, plant stage, plant location, and plant vitality or any other parameters such as presence of pest in the field or quality of soil, etc.

In some examples, the interface may receive a priority matrix which may have many parameters including the first probability score threshold and the second probability score threshold and the priority of each parameter as explained herein. The treatment unit therefore treats the portion of the field based on the priority matrix as it defines different scenarios under which the thresholds are met and not met. The priority matrix may assign importance to each parameter and define different criteria based on environmental and other changing conditions. For example, the priority matrix may change the priorities of parameters depending on the temperature at the filed or similarly seasonal changes.

In some embodiments of the present disclosure, the treatment unit of the system may include a sprayer for spraying the field with different types of materials such herbicide, pesticide, fungicide, or even fertilizer . In one example, the treatment may even include performing further sampling of the field to collect further data on different parameters.

In some embodiments, the treatment unit may be an embedded part of on a UAV or attached to a UAV using connecting members as described herein. In one example, the treatment unit may be attached or be embedded in a ground vehicle, a manned aerial vehicle, ground robots or a typical agricultural machinery. It will be appreciated that more than one vehicle including any combination of UAVs, ground vehicles, manned aerial vehicle, ground robots or a typical agricultural machinery may be used simultaneously to perform the treatment of the field.

In some examples, the treatment unit and data collection system may be embedded in the same vehicle as the treatment unit while in some other examples they there may be different vehicles handling each of these tasks separately.

In one other broad aspect, the present disclosure provides a field treatment system which includes a data collection unit for collecting data on a portion of a field, a treatment unit, an interface, a control unit. The control unit comprises a processor; and a non-transitory computer- readable medium containing instruction that, when executed by the processor, causes the processor to perform, collecting data on the portion of the field using the data collection unit, receiving a first parameter to be considered for treatment of the portion of the field and a first probability score threshold for the parameter, calculating a first probability score of the first parameter related to the portion of the field in the data; and treating the portion of the field based on the first probability score of the first parameter and the first threshold using the treatment unit.

In some examples, the system may further comprise a vegetation detection module,

and the non-transitory computer-readable medium further contains instructions that cause the processor to apply a vegetation detection process to the collected data.

In one example of the present system, the treating of the portion of the field may include treating the portion when the probability score of the parameter is equal or higher than the probability score of the threshold. In another example, the treatment may include treating the portion when the probability score of the parameter is lower than the probability score of the threshold. In some embodiments, the vegetation detection process comprises applying excess green method or using the sensors such as lidar or a chlorophyll detection sensor, an infrared sensor, or near-infrared sensors to detect the vegetation.

In some examples, the system first detects vegetation using one of the methods disclosed herein and then calculates probabilities of different parameters only for the detected vegetation. This is advantageous as it may reduce the processing power required for the probability calculation. This may also increase the accuracy of the system.

In some embodiments the non-transitory computer-readable medium further contains instructions that cause the processor to perform receiving one or more secondary parameters to be considered for treatment of the portion of the field and secondary probability score thresholds for the one or more secondary parameters; calculating secondary probabilities for the one or more secondary parameters related to the portion of the field in the data; and, treating the portion of the field based on the first probability score, the secondary probabilities, the first threshold and the secondary thresholds using the treatment unit.

It will be appreciated by those skilled that the secondary parameters and the secondary thresholds may be one or more parameters depending on the requirements. Also, it would be appreciated that the first parameter and first threshold and secondary parameters and secondary thresholds do not need to be received separately. In one example, all information regarding the parameters and their threshold are received by the system through a priority matrix. In one example the priority matrix may further include other information such as the priority of each parameter and information that would be used by the system to prioritize the operation. For example, it may define different priorities or thresholds for different climates or temperatures. It would also be appreciated that the priority matrix may include information regarding the other environmental or operational variants that would change the priorities, threshold or other priority factors. In some embodiments the priority matrix can be predefined. In other examples, it may be defined or revised by a user.

In some examples, the calculations are performed by the system onsite, and the models used by the system, for any step of the process (such as AI processing, excess green, HSV). In one example, the calculations may be done using cloud computing.

In some examples, the system may be updated from time to time via uploading a new model or framework. Alternatively, the system may be connected to a cloud-based server and be updated on a continuing basis.

In some examples the non-transitory computer-readable medium may further contain instructions that cause the processor to receive a second probability score threshold for a second parameter related to the portion and calculating a second probability score of the second parameter in the data collected using the calculation module; and wherein the treatment unit treats the portion of the field based on the first and the second probability score and the first and second thresholds.

In one broad aspect, the present disclosure provides a method for using a field

treatment system which includes collecting data on a portion of a field using a data collection unit; calculating by a processing unit a probability score of at least one parameter related to the portion of the field in the data collected; assigning a probability score threshold for the at least one parameter using an interface, wherein the probability score threshold is adjustable; and, treating the portion of the field based on the probability score of the at least one parameter and the defined threshold using a treatment unit.

In some examples, the present method may also comprise detecting vegetation in the portion of the field using the processing unit by applying a vegetation detection process to the collected data. In one example the calculating the probability score of at least one parameter related to the portion of the field in the data collected comprises calculating the probability score of the at least one parameter only for the detected vegetation. In some examples, the green detection process, chlorophyll/vegetation detection process, or other heuristic algorithm may locate one or more positions of all pixels in the image data representing possible vegetable/plant life.

In one embodiment, the treatment of the field is performed when the probability score of the parameter is equal or higher than the probability score threshold while in other examples treating the field is performed when the probability score of the parameter is lower than the probability score threshold.

In some examples the collecting data on vegetation in the portion of the field using

the data collection unit includes collecting image data of the portion or the whole field. In other embodiments, it may include collecting other forms of data by different sensors and data collection devices such as lidar, infrared or even soil collection and soil quality measurement tools.

In one example, the vegetation detection may be performed by applying hue, saturation, value (HSV) color index method to the plurality of image data or by excess green method to the plurality of image data. In another example, vegetation detection process may include detecting vegetation in the field using the sensor such as lidar, chlorophyll detection sensors to detect the vegetation, infrared sensor, or near-infrared sensors.

In some examples, the assigning the probability score thresholds may include receiving a priority matrix defining, among others, the probability score threshold for the parameters to be considered for the treatment. Furthermore, the system may use the priority matrix to treat the portion or the entirety of the field.

In some examples, the treatment of the field may comprise spraying one or more of insecticide, biological agents, organic agents, and fertilizer on the portion of the field.

In another broad aspect, the present disclosure provides a method for treatment of

a field. The method includes collecting data on a portion of the field using a data collection unit; receiving by an interface a plurality of parameters to be considered for treatment of the portion of the field and probability score thresholds for each one of the plurality of parameters; calculating probabilities of each one of the plurality of parameters for the portion of the field using a processing unit; and, treating the portion of the field based on the probabilities and the probability score thresholds using a treatment unit.

In some examples, the receiving the plurality of parameters to be considered for treatment of the portion of the field and probability score thresholds for each one of the plurality of parameters may comprise receiving a priority matrix for the plurality of parameters, and wherein treating the portion of the field comprises treating the portion of the field based on the priority matrix.

In some examples, the method may further comprise detecting vegetation in the portion of the field by applying a vegetation detection process. In one embodiment, calculating the probabilities of each one of the plurality of parameters for the portion of the field comprises calculating the probabilities of each one of the plurality of parameters only in the detected vegetation.

It would be appreciated by those skilled in the art that different types and numbers of vehicles known in the art can be used for performing the data collection and/or the treatment of the field including a UAV, a ground sprayer, an unmanned ground robot, and a manned aerial vehicle or any combination of thereof. Furthermore, the processing may be performed onboard the vehicle of in a different part of the server. In another example, the processing may be completely or partially cloud based.

In some embodiments of the present disclosure, the vegetation detection process

may be used in combination with an assumptive approach, as an alternative or in combination with probability-based approach disclosed herein, for treating the field . For example, after preliminary detecting of all the vegetation, the system may assume that all the vegetation that are not in designated rows are weeds and have to be treated.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a block diagram of the current farm management process;

FIG. 2 is a physical component architecture diagram of a treatment system having a drone, a base station, and a rolling drone;

FIG. 3 is a front view photograph of an aerial drone;

FIG. 4 is a perspective view of another configuration for an aerial drone;

FIG. 5 is a side view diagram of a rolling drone;

FIG. 6 is a block diagram of various electronic components of the drone;

FIG. 7 is a system logical architecture diagram of the treatment system;

FIG. 8 is a block diagram of an autonomous drone farm management process having a crop phase 1-cycle advanced process;

FIG. 9 is a flowchart of instructions executed by the treatment system;

FIG. 10A and 10B are images of the field of view of the drone demonstrating target detection;

FIG. 10C is an image of the field of view of the drone demonstrating target

identification with confidence intervals;

FIG. 11 is a diagram of a priority matrices hierarchy;

FIG. 12 is an image demonstrating overlap between a weed object and a crop object;

FIG. 13 is a flowchart of adjusting priority matrices to generate a treatment

decision for each plant;

FIGS. 14A to 14C are example images demonstrating a combination of a plant

type identification map and a vegetation map;

FIGS. 15A to 15D are example images demonstrating steps of a herbicide treatment application map; and

FIGS. 16A to 16D are example images demonstrating steps of a fungicide

treatment application map.

FIG. 17 is a flowchart showing an exemplary method used by the system in

accordance with one embodiment of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present invention.

Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the scope of the invention. Thus, it is intended that the present invention cover the modifications and variations of this invention provided they come within the scope of the appended claims and their equivalents. Reference will now be made in detail to the preferred embodiments of the invention.

An example treatment system 250 disclosed herein may comprise any number and

combination of the technologies, systems, subsystems, components, processes, computations, and other items discussed or referred to herein and may also be modified or augmented with existing technologies known in the art upon review of the content herein and still be within the scope and intent of the content disclosed herein. The description herein may be specific to a treatment system 250 comprising one or more aerial drones and rolling drones 600 merely for convenience. In some aspects, the field treatment identification and prioritization techniques described herein may equally apply to a conventional field treatment system such as a conventional sprayer and the like.

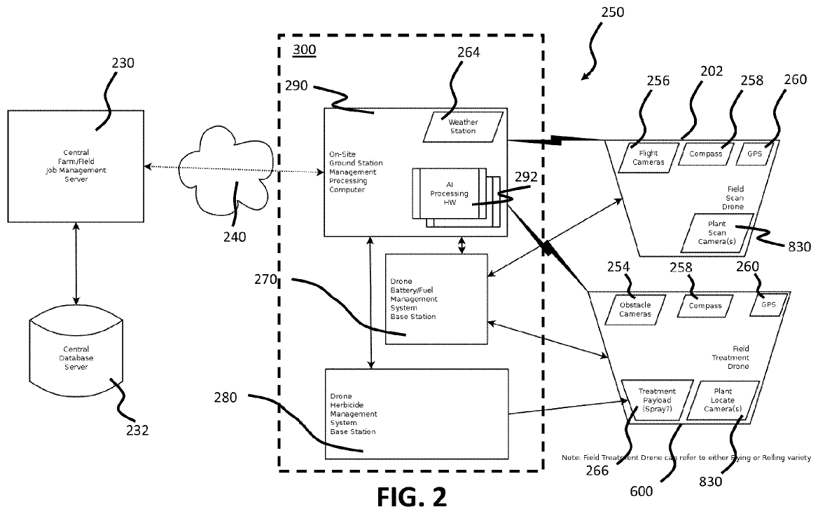

With reference to FIG. 2, the treatment system 250 may comprise one or more aerial drones 202, one or more base stations 300, and/or one or more rolling drones 600. In this aspect, the drone 202 may be an aerial drone 202 capable of autonomous flying over a field. The aerial drone 202 may land on or near the base station 300 in order to receive electrical power and/or pesticide from the base station 300. Similarly, the rolling drone 600 may likewise be capable of autonomous movement around the field and may dock with the base station 300 in other to receive electrical power and/or pesticide from the base station 300. In some aspects, the base station 300 may retrieve data from the aerial drone 202 and/or the rolling drone 600. In some aspects, the rolling drone 600 may act as a mobile base station 300 for the one or more aerial drones 202.

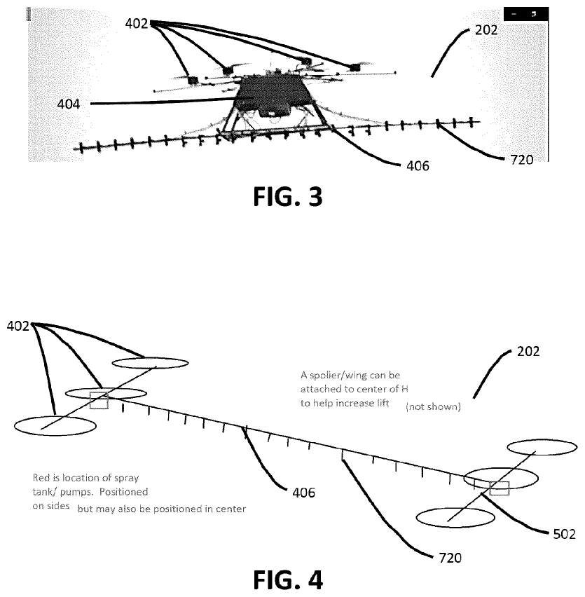

The treatment system 250 may have the base station 300 separated into one or more discrete stations 270, 280, 290. The base station 30 may be separated into a battery/fuel management base station 270, a drone pesticide management system base station 280, and an on-site ground station management processing computer 290. It may be appreciated that these three base stations b 270, 280, 290 may be combined into a single base station 300. In this aspect, there may be one or more field scanning drones 202 and one or more field treatment drones 600. The field scanning drones 202 may be aerial drones, as described with reference to FIGS. 3, and 4, instrumented with one or more flight cameras 256, a compass 258, and a GPS 260. In some aspects, the field scanning drone 202 may comprise one or more plant scanning cameras 830 separate from the flight cameras 256. In other aspects, the plant scanning cameras 830 and the flight cameras 256 may be the same camera. The field scanning drone 202 may traverse the field gathering field data in order to wirelessly relay the data to an on-site ground station management processing computer 290. The field scanning drone 202 may dock with a battery/fuel management base station 270 in order to receive one or more new batteries and/or fuel.

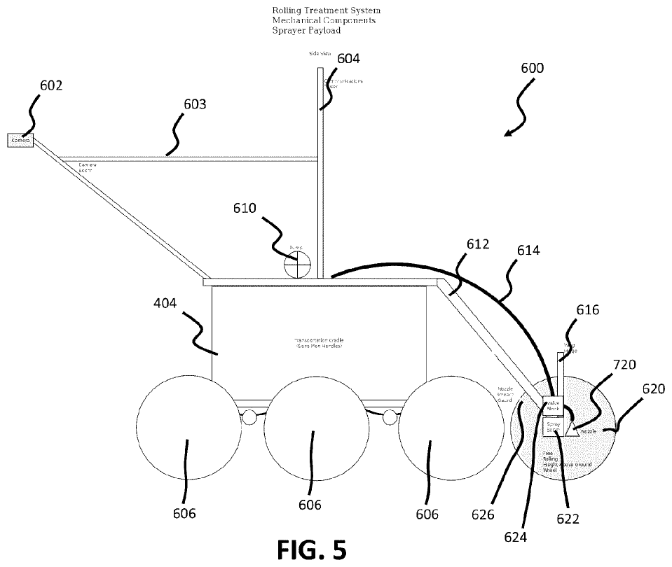

In another aspect, the field treatment drones 600 may be a rolling treatment drone 600 described in further detail below with reference to FIG. 5. Similar to the field scanning drones 202, the treatment drone 600 may comprise a compass 258 and a GPS 260. The treatment drone 600 may comprise one or more obstacle cameras 254 for imaging a path of the treatment drone 600. In some aspects, the treatment drone 600 may comprise one or more plant locating cameras 830. The treatment drone 600 may also comprise a treatment payload 266 to treating particular pests. Although the aspect described is directed to the rolling treatment drone 600, other aspects may have a field treatment drone 600 be an aerial drone 202 as described in FIGS. 4 and 5. Similar to the field scanning drone 202, the field treatment drone 600 may dock with the battery/fuel management base station 270. In addition to the battery/fuel management base station 270, the treatment drone 600 may also dock with a drone pesticide management system base station 280. The treatment drone 600 may also wirelessly communicate with the on-site ground station 290.

The on-site ground station management processing computer 290 may comprise a weather station 264 and one or more artificial intelligence processing hardware 292. The on-site ground station management processing computer 290 may communicate with the drones 202, 600 as well as the respective base stations 270, 280. The processing computer 290 may also communicate via a wired network over an Internet 240 with a central farm/field job management server 230. The job management server 230 may retrieve and store data to a central database server 232.

Turning to FIG. 3, an aerial drone 202 is demonstrated. In this aspect, the aerial drone 202 comprises six or more propellers 402 above a housing 404, and a horizontal spray boom 406 located below the housing 404. The horizontal spray boom 406 may comprise between 12 and 24 spray nozzles 720, each controlled individually with their respective valves. In this aspect, the number of spray nozzles 720 is 24.

Turning to FIG. 4, another configuration for an aerial drone 202 is demonstrated. In this aspect, a centrally located horizontal spray boom 406 may be coupled at each end to a propeller arm 502 resembling an extended H-configuration when viewed from a top view. Each of the propeller arms 502 may comprise one or more propellers 402. One or more wings and/or spoilers (not shown) may be included to ensure lift over the center section when traveling in a forward direction. In this aspect, each propeller arm 502 is coupled to three propellers 402 for a total of six propellers 402. In this configuration, the effect of downwash from the propeller blades on the spray nozzles 720 may be reduced or eliminated. In this aspect, the spray boom 406 may have up to 32 spray nozzles 720.

Turning to FIG. 5, the rolling treatment drone 600 is shown. In this aspect, the drone 600 may comprise a plurality of wheels 606 on both sides of a transportation cradle or housing 404. A camera housing 602 may be mounted on a camera boom 603 above the transportation cradle or housing 404. The camera boom 603 may be coupled to a communication tower 604. The communication tower 604 may be configured to communicate with the base station 300. Located at a rear of the drone 600 may be a one or more free rolling wheels 620 that have a height generally above the ground. In this aspect, there are four free rolling wheels 620. Between each of the free rolling wheels 620 may be a spray boom 622 acting as an axle for each of the wheels 620. The spray boom 622 may be supported by a pair of wing hinges 616 and may have a nozzle impact guard 626 in order to protect the nozzles 720 from damage. Mounted on the spray boom 622 may be a valve block 624 and a spray nozzle 720 between each of the free rolling wheels 620. Each valve block 624 may control an amount of pesticide spray to each spray nozzle 720. A pump 610 may be mounted above the transportation cradle 608 and may be connected to a hose 614 to the valve blocks 624. The pump 610 may supply pressure of the liquid pesticide to the valve blocks 624.

Although the term treatment unit or spraying system 700 is used herein, this term is not intended to be limiting and spraying is only one of different treatment methods proposed by this disclosure .

The spraying system 700 may comprise a chemical spray and/or a chemical applicator such as a wick or swab applicator. The spraying system 700 as used herein may also comprise any other system of treatment that deploys one or more chemical and/or organic substance in response to a command. The drone 202, 600 may comprise a non-chemical treatment system that may deploys a non-chemical treatment. The non-chemical treatment may comprise an energy treatment such as heat (or fire), sound, radiation, electricity, mechanical removal, etc. The spraying system 700 may comprise both chemical and non-chemical treatment applications.

In another aspect, instead or in addition to the sprayer 700, the processor 802 may

instruct a microwave or high-energy laser beam directed at the weed 1620, 1622. In another aspect, the processor 802 may instruct the drone 202, 600 to land on or approach the weed 1620, 1622 and activate a weed eradication device (not shown), such as a weed trimmer, heater, sprayer, digger, microwave, high-energy laser, electric discharge, etc.

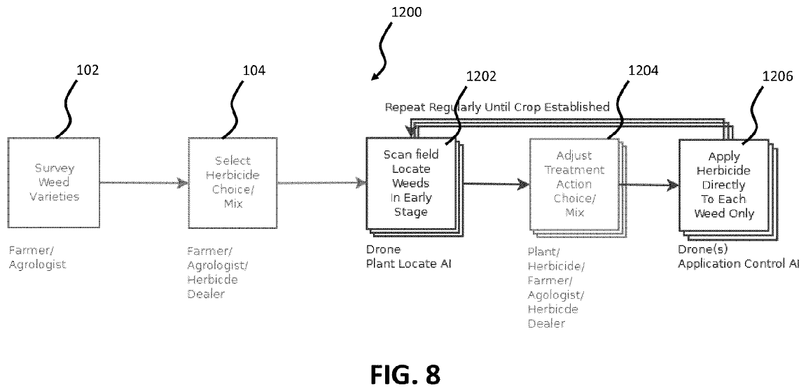

The drone 202, 600 may have a housing 404 coupled to one or more motors 810 with a frame or housing 404. In this aspect, the housing 404 may be a generally square or a rectangular box with a generally hollow interior for holding one or more components 800. For the aerial drone 202, the one or more motors 810 may spin one or more propellers 402 using one or more gears 822. The propellers 402 may be protected using one or more guards (not shown) that may be coupled to the motors 810 or the housing 404. An agricultural sensor probe (not shown) having one or more agricultural sensors 812 may be present on proximate to a bottom of the housing 404 and configured to contact the ground when the aerial drone 202 has landed and/or be extended to contact the ground for the rolling drone 600. The one or more components 800 within or mounted to the housing 404 may comprise one or more printed circuit boards (PCBs) (not shown) having a number of electronic components and/or electromechanical components described in further detail with reference to FIG. 8 below.

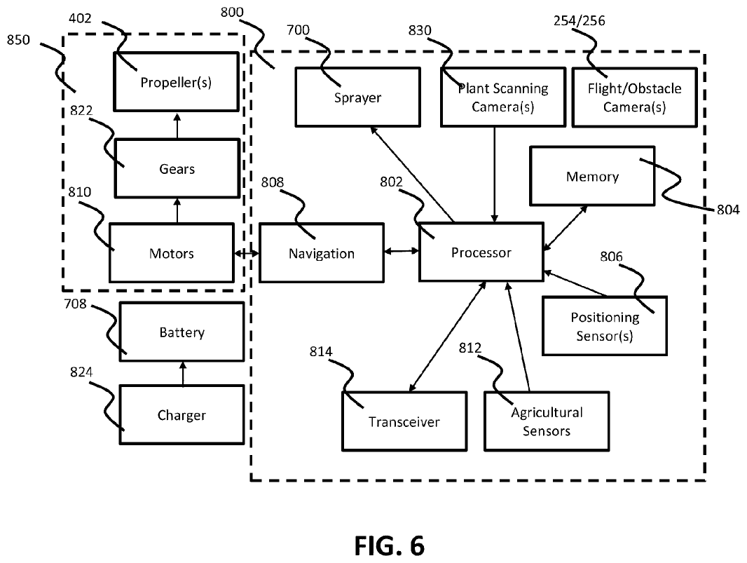

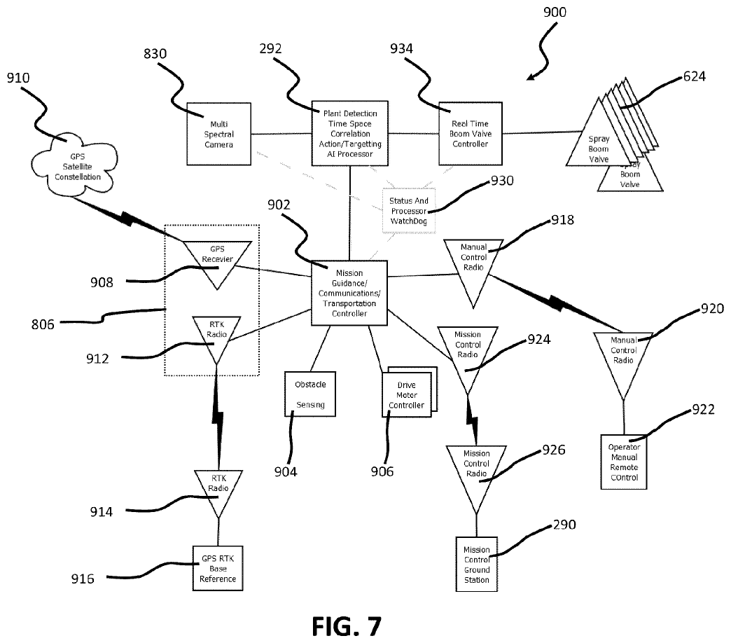

As shown in FIGS. 6 and 7, a computing system 800 for the treatment system 250 is demonstrated. The computing system may comprise a processor 802 may execute computer-readable instructions from a tangible computer-readable medium 804 (e.g., memory) and the processor 802 may store data to the memory 804. The processor 802 may execute instructions in order to capture image data from one or more camera(s) 830. The camera(s) 830 may have a field of view generally below and/or in front of the drone 202, 600. At least one of the camera(s) 830 may have a field of view generally in a direction of motion of the drone 202, 600. In some aspects, at least one of the camera(s) 830 may automatically change direction to the direction of motion of the drone 202, 600. In other aspects, the drone 202, 600 may rotate in order to align the field of view along the direction of motion of the drone 202, 600. The processor 802 may execute one or more instructions to implement a plant detection and targeting system 292.

Various aspects of the drone 202, 600 may comprise a communication system 814, the navigation system 808, the spraying system 700, and/or a treatment success verification system. The drone communications system 814 may comprise one or more wireless communication devices and/or a chipset such as a BluetoothTM device, an 802.11 or similar device, a satellite communication device, a wireless network card, an infrared communication device, a Wi-Fi device, a long-range antenna (LoRa), a Real-Time Kinematic (RTK) antenna, a WiMAX device, a cellular communication device, etc. and other communication methods, devices and systems available or available in the future. The drone 202, 600 may also comprise a data bus between onboard systems and subsystems.

The data collection system or unit may comprise any one of or any combination of one or more cameras 254, 256, 830, one or more sensors 806, 812 or other types of sensors such as lidar sensors, chlorophyll detection sensors, infrared sensors, or a near-infrared sensors, and/or other data gathering devices. It is to be understood that the data collection system may include an array of various different sensors configured to collect data within a predefined proximal distance from the drone 202, 600, and transmit the sensor/image data back to the internal software systems of the drone 202, 600 (e.g., the targeting system 292, the spraying control, the spray vectors engine) and/or to the base station 300 and/or a display device of mission command center 902 for outputting to an operator. The data collection system or unit may provide data to identify objects using the cameras and sensors as described above.

This object data may be provided to the targeting system 292 which uses the mission rules and object comparison data to determine if the object is the target for this mission, the target for another mission, the non-target to be protected from spraying, an obstacle to be avoided and/or an object to be ignored.

Various aspects of the drone 202, 600 may comprise systems or subsystems for

automatic detection of objects and for determining if an object is to be treated according to one or more mission rules. An object to be treated according to the mission rules may be sometimes referred to as a target. An object that is identified whereby treatment of the object is to be expressly avoided according to the mission rules may be sometimes referred to as a non-target. Various aspects of the drone 202, 600 may include capabilities for automatic detection of objects that the drone 202, 600 may physically avoid according to the mission rules or objects to be ignored altogether in this mission or future missions. The mission rules may be used to differentiate between objects, determine if an object is to be avoided with treatment, to select targets to be sprayed, to prioritize targets, to deselect targets, to re-select targets. The mission rules may be used to determine when, where and how the navigation system 808 may use active stabilization. The mission rules may include spray vector solutions or be used by the drone 202, 600 to determine spray vector solutions automatically. The mission rules may be used to achieve target identification, single instance target tagging, continuous and intermittent target tracking, etc.

In some aspects, the camera(s) 830 working as data collection unit may be affixed or integrally formed with a body of the drone 202, 600. In other aspects, the camera(s) 830 may be extended on an arm 603 that may rotate 360-planar degrees and/or extend up to 2 meters outside of the perimeter of the drone 202, 600 (e.g. a circumference of the drone 202, 600). By placing the camera(s) 830 on the arm 603, the camera(s) 630 may be positioned in a way such that the image may be taken before a propeller wash for aerial drones 202. This configuration may permit more clear images to be captured before the propeller wash, which causes the plants to be buffeted around and/or sideways. In another aspect, the camera(s) 830 may be located on a gyroscope or other stabilizing apparatus to minimize jitter and/or shaking of the camera(s) 830. The arm 603 may also have some mechanical components (not shown) to adjust a camera angle slightly to follow an incline of a terrain of the field. For example, when the drone 202, 600 travels down a steep incline, the camera(s) 830 may image the field at a slightly inclined angle such as to make the images appear “flat” or consistent to an artificial intelligence (AI) framework 292. In other aspects, digital post processing may correct for any distortion and/or blurriness of the camera(s) 830.

The camera(s) 830 may comprise a lens, a filter, and an imaging device, such as a CCD or CMOS imager. In some aspects, the filter may only permit certain wavelengths of light to pass through and be captured by the imaging device. For example, the filter may only permit infrared light to pass through. In another example, the filter may only permit ultraviolet light to pass through. In yet another example, the filter may only permit visible light to pass through. The visible light filter may be a filter mosaic in order to permit the image sensor to capture red-green- blue (RGB) colored light. In another aspect, the filter mosaic may also include infrared, ultraviolet light filters, and/or any number of filters, such as 10 bands) that divide light into specific frequency bands. The frame rate of the imaging device may be selected based on the number of filters, such as 30 frames-per-second (fps) per filter. In this aspect, the imaging device may have five filters and therefore the imaging device may have a frame rate of at least 150-fps. In other aspects, the frame rate may be higher or lower for a particular filter. According to some aspects, the camera(s) 830 may capture image data at 30 frames-per-second at a 4k resolution or greater. The processor 802 may be configured to perform image processing on the captured image data as described in further detail below.

In some aspects, the drone 202, 600 may comprise one or more light-emitting diodes (LEDs) for projecting light from the drone 202, 600 into the field of view of at least one of the cameras 830. The LEDs may project infrared light, ultraviolet light, red light, blue light, green light, white light, and/or any combination thereof. In some aspects, the processor 802 may modulate the LEDs and/or control an on/off state. In some aspects, the LEDs may start with wavelengths not visible to most pests, such as insects, in order to more accurately determine their position without disturbing the pests.

The processor 802 may read position data from one or more positioning sensor(s)

806, such as an altimeter, ultrasonic sensors, radar, lidar, accelerometers, etc. In some aspects, the positioning sensor(s) 806 may be a pair of cameras 830 capturing binocular vision from the drone 202, 600. In some aspects, the processor 802 may triangulate a position of one or more features external to the aerial drone 202 in order to assist with navigation by a navigation system 808. The navigation system 808 may provide instructions to the one or more motors 810. In this aspect, the navigation system 808 may be performed using the processor 802. In another aspect, the navigation system 808 may be independent of the processor 802.

In another aspect, the navigation system 808 may comprise one or more navigation and/or positioning sensors 806, such as a GPS system, an altimeter, ultrasonic sensors, radar, lidar, etc. In some aspects, the positioning sensor 806 may be a pair of cameras 830 capturing binocular vision from a separate drone 202, 600 or a remotely located and fixed-position binocular camera system 830, such as a pole-mounted camera system. In some aspects, the processor 802 may triangulate one or more locations of one more feature external to the drone 202, 600 and triangulate a drone position using the one or more features external to the drone 202, 600 in order to assist with navigation by the navigation system 808. The navigation system 808 may receive input from the data collection system to assist with navigation. The navigation system 808 may track a specific location of the drone 202, 600 relative to a previous location and may do so continuously in order to command the drone motors 810 to propel the drone 202, 600 to follow a desired path from the base station 300 to a treatment area and then within the treatment area.

The navigation system 808 may provide instructions to control the movement of the drone 202, 600. The navigation system 808 may determine a first drone location and/or orientation, then be provided a desired second drone location and/or orientation, calculate a propulsion to move the drone from the first location to the second location and issue commands to move the drone 202, 600 in any number of desired directions, orientations, velocities and/or accelerations. The navigation system 808 may comprise internal processors (not shown) to calculate the propulsion and/or may rely on processing resources 802 external to the navigation system 808 to calculate the propulsion with the navigation system 808. The navigation system 808 may issue commands to the drone mechanical system 850, such as motors 810 and gears 822, to control the propulsion system 850, such as wheels 606 and/or propellers 402, to control the movement of the drone 202, 600. The control and movement may include commands directed to pitch, elevation, yaw, azimuth, forward, backward, left, right, etc.

The accelerometers may be used to detect and respond to drone 202, 600

accelerations and vibrations. Such accelerations and vibrations may be caused by weather, terrain, other external influences, and/or mechanical vibration and movement of the drone 202, 600. The drone 202, 600 may include rate gyros to stabilize the drone 202, 600 and magnetometers and accelerometers used for canceling gyro drift. The global positioning system components or other positioning devices 806 may be included to determine the drone location, heading, and velocity to compute spraying solutions, and to target known treatment target coordinates such as a tree stump or other woody plants that are designated for repeated spraying across multiple missions.

The drone 202, 600 may comprise the drone mechanical system 850 and the drone

mechanical system 850 may comprise a propulsion system 850. The mechanical system 850 may comprise motors 810 driving a transmission system 822, including gears 822, that may in turn drive shafts (not shown) that may drive wheels 606, rotors or similar components or any combination thereof to create propulsion. The mechanical system 850 may comprise direct drive motors 810 not requiring gears 822 or a combination of direct drive and/or gear drive components.

The mechanical system 850 may be commanded by a mechanical control system 850 and/or receive commands directly from the navigation system 808. The mechanical system 850 of the drone may comprise one or more motors 810 to move the drone 202, 600 to the second location.

The drone 202, 600 may have one or more agricultural sensors 812 located on a sensor probe (not shown) or alternatively on the wheel 606. The processor 802 may periodically instruct the navigation system 808 to land the drone 202 or instruct the probe to move into the soil for the rolling drone 600 at positions in a field. When the drone 202, 600 has landed or reached a sufficient distance depending on whether or not the sensor 812 requires contact with the field, the processor 802 may read agricultural data from one or more agricultural sensors 812, such as soil acidity, soil moisture, temperature, conductivity, wind, gamma radiation sensor, and/or other radiation sensors, etc. used to construct a soil profile and/or a plant profile.

In some aspects, the sensors 812 may be inserted into the soil via a hydraulic press, auger system, located on the wheel 606, and/or combination thereof and the sensor 812 may record measurements within the soil and thereby reducing or eliminating the need to collect soil. In another aspect, the sensor 812 may not be inserted into the soil but rather the soil may be collected via an auger system (not shown) or a grapple (not shown) and analyzed by one or more sensors 812 within the drone 202, 600. In yet other aspects, the sensor 812 may not be located on or within the drone 202, 600 and the drone 202, 600 may collect the soil via the auger system or the grapple and may store the soil in a soil canister (not shown) for analysis by the base station 300 and/or delivered to a laboratory. In other aspects, the sensors 812 may be able to remotely sense without requiring physical contact with the soil. For example, one or more sensor readings may be performed by measuring radiation, magnetic fields, and/or spectral analysis. In some aspects, a liquid application system (not shown) may apply a liquid, such as water, to the soil to facilitate softening the soil for collection.

According to some aspects, the processor 802 may perform image processing on the captured image data at a location in order to determine one or more of these characteristics as described in further detail herein.

The processor 802 may communicate via a wireless transceiver 814. The wireless transceiver 814 may communicate using Wi-Fi, Bluetooth, 3G, LTE, 5G and/or a proprietary radio protocol and system, etc. The processor 802 may communicate with the base station 300 in order to relay status data, such as fuel, battery life, pesticide amount, position, etc. and/or agricultural data. In another aspect, the status data and/or agricultural data may be stored in internal memory, such as an SD card and/or a hard drive) until the processor 802 is within communication range (e.g., the wireless transceiver 814 has a stable connection with the base station 300 or when the drone 202, 600 docks with the base station 300).

A battery 708 may be used to power the motors 810 and the other electronic components 800. In some aspects, the battery 708 may only be used to power the other components 800 and a gasoline, hydrogen, or other combustible fuel engine may be used to power the motors 810. The motors 810 may be coupled to one or more propellers 402 via one or more gears 822. One or more chargers 824 may be used to recharge the battery 708.

Turning to FIG. 7, an electronic system 900 for the rolling drone 600 is presented. The electronic system 900 comprises a controller 902 for mission guidance, communications, and/or transportation. A watchdog 930 monitors the system 900 for lockup and/or other anomalies.

The controller 902 may receive obstacle data from an obstacle sensing system 904 and provide output to a drive motor controller 906. The controller 902 may communicate with a plant detection time space correlation action/targeting AI processor 292 that may receive one or more images from the multi-spectral camera 830. The AI processor 292 may also send signals to a real-time boom valve controller 934 that may initiate the pesticide spray from the spray boom valves 624.

For the navigation system 808, the controller 902 may receive positioning data from one or more positioning sensors 806, such as from one or more GPS coordinates from a GPS receiver 908 in communication with a GPS satellite constellation 910. The positioning sensors 806 may also comprise the controller 902 receiving a signal from a real-time kinematic (RTK) radio 912 from a GPS RTK base reference 916 transmitting via another RTK radio 914. The navigation system 808 may receive this information in order to plan routing of the drone 600 and/or calculate the relative GPS RTK coordinates of weeds/pests within the image data captured by the drone 202, 600.

The controller 902 may also receive manual control instructions from a manual control radio 918. An operator manual remote control 922 may transmit the manual control instructions via a manual control radio 920 to be wirelessly received by the manual control radio 918 in the drone 600. The controller 902 may also wirelessly communicate with a mission control ground station 290 over a pair of mission control radios 924, 926 operating on the same frequency. In this aspect, the mission control ground station 290 may control the missions and the base station 300 may perform recharging and/or swapping drone batteries or spray.

Turning to FIG. 8, an autonomous drone farm management process 1000 having a

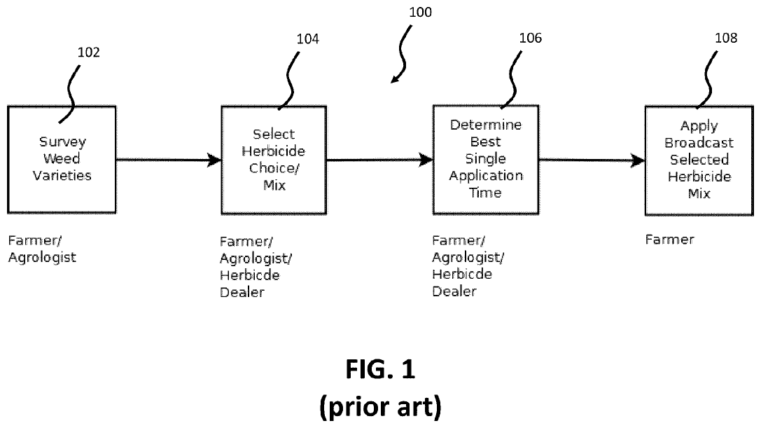

crop phase 1-cycle advanced process is shown. Steps 102 and 104 may be the same as previously described with reference to FIG. 1. In this aspect, the drone 202, 600, in particular to aerial drone 202, may perform a scanning process 1202 in order to locate any pests in the field. During the scanning process 1202, the base station 300 and/or the mission command center 292 may include a rules data store which may include identification rules for plants, pests or other target types. The rules data store may include one or more target selection and target priority rules. The rules data store may include one or more spraying rules, and other chemical application rules specific to the mission, the chemical(s) being applied, the target, and any other data input. The rules data store may include treatment rules, spraying rules, and/or other chemical application rules specific to the mission, including the chemical(s) being applied, the target, and any other data that may be useful in processing and understanding camera/sensor data input. The drone 202, 600 may include a local onsite data store within the memory 804 which may include identification rules for specific targets, non-targets, plants, pests or other types of objects. The rules data store may include object or target identification, selection and prioritization rules.

Periodically, a treatment action 1204 may be adjusted using one or more prioritization matrices described in further detail below. In general, a broad-scope aerial survey may be performed at high altitude in order to identify key areas requiring treatment within a 1-m by 1-m space, or other size depending on a resolution of the system. For each of these treatment areas, a low-altitude drone 202, 600 may survey at a lower altitude (e.g., high resolution) and may determine one or more precise coordinates of pests to spray. A pesticide application process 1206 may then instruct one or more of the drones 202, 600 to apply the pesticide directly to each area of the field impacted by the pest and/or directly to the pest itself. In alternative aspect, the pesticide application process 1406 may provide the location and/or coordinates of the identified pests to a manually controlled system, such as a high clearance sprayer or may provide a map to a farmer with a manual sprayer.

The treatment system 250 may execute a treatment mission whereby one or more drones 202, 600 may be used to identify objects within the treatment area to be treated to allow the objects so identified to be distinguished one from another. The drone 202, 600 may be used to identify objects to be treated from objects that are not to be treated and from objects that are to be ignored or otherwise dispositioned. The treatment system 250 may execute a treatment mission whereby one or more drones 202, 600 may be used to treat the objects identified for treatment.

In another aspect, on detection of the pest by the processor 802, the processor 802

may record the GPS/RTK coordinate data and/or other spatial sensing data (e.g., accelerometers, etc.) to determine the spray location without the use of cameras. The GPS/RTK coordinate data may then subsequently be used by a spray drone 202, 600 that performs treatment of the one or more identified weeds.

An AI framework 292 may modify the priorities within one or more mission rules. For example, targets may have different characteristics such as type or size or proximity to the drone or proximity to a non-targeted plant or object. Any one or all of these may generate different spraying priorities. Thus, the AI framework 292 may be required to prioritize the targets as the targets are identified. The prioritization process may be included in the identification or verification steps or may be a separate step. The prioritization may result in targets being tagged for later treatment or ignored. The prioritization may affect the order in which the targets are sprayed, or which spray nozzle 720 is used. The prioritization may result in multiple spray nozzles 720 being used to treat the same target. The prioritization may affect calculation of spray vectors. In some aspects, the prioritization may determine a type of treatment, such as, for example, larger targets may receive chemical treatment whereas small targets may receive an energy treatment. The prioritization is described in further detail below.

In one aspect, the drone 202, 600 may detect objects and identify and verify one or

more targets, using the camera 830 and/or the sensors 806, 812 and may use additional data sources. For example, the image data from cameras 830 and the sensor data from the sensors 806, 812 may be used to detect one or more objects. The same data or additional data may be used to identify the object as a target or potential target. The object may be tagged for further analysis prior to being added to the target list, being tagged or being ignored. The further analysis may be performed using the same or additional data such that the drone is made to collect additional data for analysis. In this way a predictive first analysis may be performed that requires fewer analysis resources and reduced analysis time. The predictive first analysis can be used to optimize the drone resources 800 and only commit drone system resources 800 to objects that are predicted to be targets. The predictive first analysis may be followed by a second analysis or a series of analysis prior to being added, or not, to the target list. An object may be added to the target list based on one, two, or any number of analysis cycles consistent with mission rules. The target list may be verified prior to or after a spray vector has been calculated.

In another aspect, the base station 300 may detect objects and identify and verify one or more targets, receiving data from the cameras 830 and/or the sensor units 806 of the drones 202, 600 and may use additional data sources. For example, the image data and the sensor data may be used to detect one or more objects. The same data or additional data may be used to identify the object as the target or potential target. The object may be tagged for further analysis prior to being added to the target list, or be tagged a non-target or be tagged to be ignored. The further analysis may be performed using the same or additional data such that the drone 202, 600 is made to collect additional data for analysis. In this way a predictive first analysis may be performed that requires fewer analysis resources and reduced analysis time. The predictive first analysis can be used to optimize one or more resources of the drone 202, 600 and only commit the resources to objects that are predicted to be targets. The predictive first analysis may be followed by a second analysis or a series of analysis prior to being added, or not, to the target list. An object may be added to the target list based on one, two, or any number of analysis cycles consistent with mission rules. The target list may be verified prior to or after a spray vector has been calculated.

The targeting system 292 adds the target to the target list to be sprayed and the

target so added to the target list is identified to the spray vector calculation subsystem within the targeting system 292. The flagged target is added to the target list so that the target's desired contact area and spray center point may be computed. The target list may comprise one or more GPS/RTK coordinates and one or more heights above the ground.

The targeting system 292 may receive input data from various data sources, and analyze the data to identify, select, and prioritize targets, track real-time or near-real-time relative target location, calculate and converge on spraying solutions, and control drone spraying. The targeting system 292 may receive data from the cameras 830 and/or the sensor units 806, 816. The data may include drone location data, drone movement vectors, drone vibration data, weather data, target images, distance/range data, infrared data, and any other sensor data described herein. The drone 202, 600 may include a rules data store which may include identification rules for plants, pests or other target types. The rules data store may include target selection and target priority rules. The rules data store may include spraying rules, and other chemical application rules specific to the mission, the chemical(s) being applied, the target, and any other camera/sensor data input.

In one aspect, the drone 202, 600 may identify a desired contact area for the treatment to be applied to the target. The desired contact area may be a portion of the target based on target-specific characteristics such as those used for verification or may be a result of the verification step. The desired contact area may be determined at any point in the process. The contact area may be any particular shape or size relative to the target. The target area may be determined based on the mission objectives and parameters. For example, if the mission is to spray weeds with an herbicide, a contact area for a targeted weed may include a portion of a leaf, an entire leaf, a group of leaves, stem, root(s), or the entire plant. In another aspect, the base station 300 may identify the desired contact area for the drone 202, 600 to treat the target.

An object detection may involve an analysis of the image data, sensor data, etc., to detect one or more objects that may be targets within a proximity of the drone 202, 600 based on the mission rules. The target identification may involve comparing object data and characteristics to a target data base or target identification rules to recognize desired targets and distinguish targets from non-targets. The target identification rules may be based on one or more GPS/RTK coordinates, relative locations to other objects, and/or visual characteristics. For example, the object may be detected and compared to the onboard plant database to identify the object as a weed or pest and distinguish the object from a non-target desirable plant and/or a weed or pest that has already been treated. Further, the identified weed may be added to the target list for verification or tagged for future treatment depending on the mission rules. If the object detected is not matched to the onboard plant database, the data may be relayed to the base station 300 or the mission command center 292 for further analysis with a more extensive plant database. The onboard plant database of each drone 202, 600 may be subsequently updated with the newly identified plant in order to facilitate more efficient determination of the plant by other drones 202, 600.

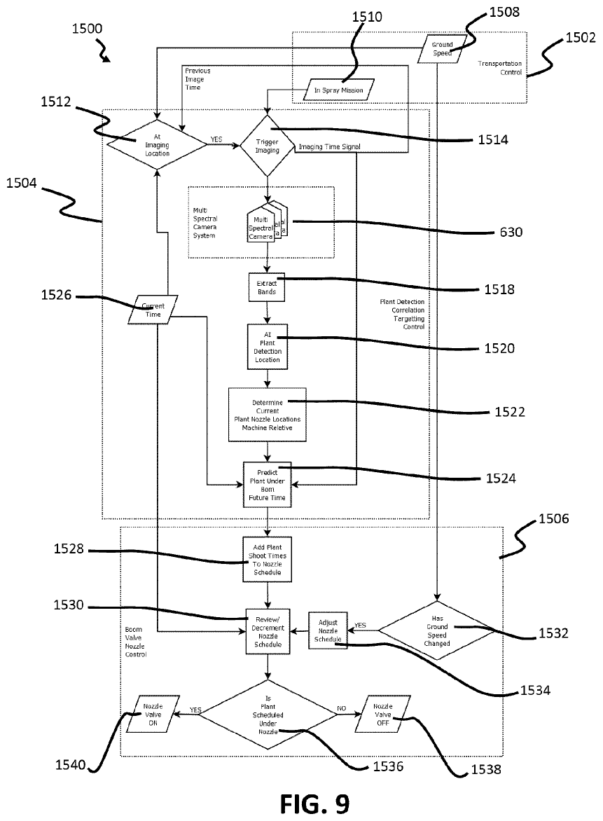

FIG. 9 presents a process 1500 generally executing on the electronic system 900

for the rolling drone 600. Other aspects may have the process 1500 executing on the computing system 800 of the aerial drone 202. Even further aspects may have the process 1500 executing across a combination of drones 202, 600 and/or base stations 300. The process 1500 may generally comprise a transportation control 1502, a plant detection correlation targeting control 1504, and/or a boom valve nozzle control 1506. The transportation control 1502 may receive or calculate a ground speed 1508 of the rolling drone 600 and may execute a spray mission 1510.

If a spray missions 1510 has been executed, the targeting control 1504 may

determine if the rolling drone 600 is at an imaging location 1512. If the rolling drone 600 is at the imaging location 1512 and if the spray mission 1510 has been executed, then an imaging process 1514 is triggered. The imaging process 1514 triggers a multispectral camera system 830, comprising one or more multispectral cameras, to capture image data.

When the image data has been captured, an extraction process 1518 may extract one or more frequency bands from the image data. A plant or pest detection location AI process 1520 may process the one or more frequency bands to determine a location of the plants. In another aspect, one or more geometric shapes of the pests may be used to determine a pest type. A combination of the frequency bands and the geometric shape identification may be used to further improve the determination of the pest type.

A current position of the nozzles 720 may be determined by process 1522 relative

to the location of the rolling drone 600. A predictive process 1524 may then predict, based on a current time 1526, a predicted time when the plant or pest will be under the nozzles 720.

The nozzle control 1506 may then add the predicted time to a nozzle schedule 1528. A nozzle scheduler process 1530 may receive the nozzle schedule 1528, the current time 1526, and any changes in the ground speed 1532. If the ground speed 1532 has changed, then the nozzle schedule 1528 may be adjusted at step 1534. If the current time 1526 has reached the predicted time on the nozzle schedule 1528 at step 1536, then the nozzle valve may be turned on at step 1540. If the current time 1526 has not reached the predicted time on the nozzle schedule 1528 at step 1536, then the nozzle valve may be turned off at step 1538.

While the aerial drone 202 is passing over the field, the processor 802 may be

processing image data from the cameras 806 using an artificial intelligence (AI) framework 292 such as described herein in order to detect pests and/or areas of undesirable growth and flag a pest area as a treatment area. When the processor 802 determines a pest is located on a planned path, the navigation system 808 may be instructed to land or lower or hover the aerial drone 202 within spraying (or treatment distance) once the aerial drone 202 reaches that point on the planned path. In another example, when the processor 802 determines a pest is not located on the planned path, the navigation system 808 may be instructed to deviate from the planned path by a certain threshold, which may be based on a proportion to row spacing and/or crop canopy size. In another aspect, the navigation system 808 may plan to land the aerial drone 202 at pests not on the planned path during a return path to the base station 300. If most of the field is in a specific color space (e.g., “green” for plants and “black” for dirt), the AI framework 292 may determine a geometrically significant feature in another color space (e.g., “gray” for gravel road, or “blue” for pond, or “red” for tractor).

In another aspect, the processor 902 may determine the location of every pest and plan a treatment path using the plant detection artificial intelligence framework 292. In some aspects, the processor 902 may provide one or more GPS-RTK coordinates for each weed and/or pest, which may be used by subsequent treatment system(s) to create one or more missions, plan paths, and/or trigger spray nozzles based on sensor positioning data. The plant detection artificial intelligence framework 292 may determine the treatment path, at least in part, by an amount of pesticide required for the number and type of pests found and/or the amount of herbicide or fungicide present in the reservoir.

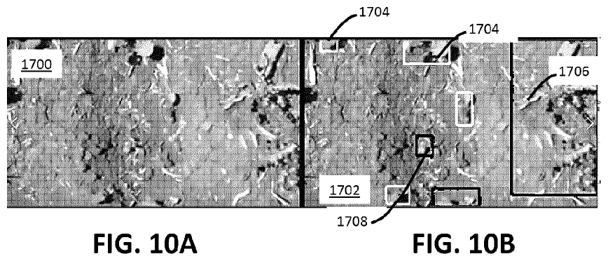

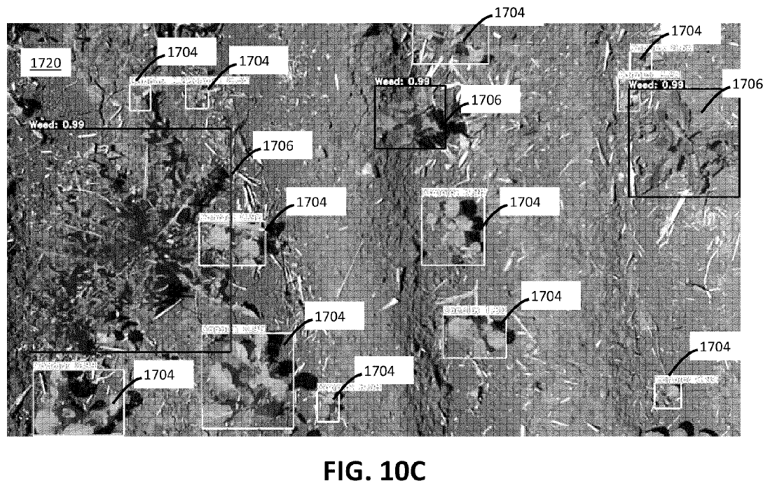

In the example presented in FIG. 10A and 10B, one or more weeds may be

determined. These techniques described may equally apply to other types of pests, such as insects, disease, and/or damaged plants. As shown in FIG. 10A, an initial image 1700 may be captured by the data collection system using one or more of the cameras 256, 830 and processed by the object detection of the AI framework 292. FIG. 10B shows the image 1702 following the object detection processing. The object detection has identified crop plants 1704 (e.g., surrounded by white boxes) and identified weeds 1706 (e.g., surrounded by black boxes) and surrounded those identified plants 1704 and weeds 1706 with one or more bounding boxes that have been calculated. Based on the bounding box, a center point may be determined using the bounding box and may correspond to the spray target area. In some aspects as described herein, only weeds 1706 of a sufficient size may be targeted whereas weeds 1708 below a certain size may not be targeted until the weed 1708 has grown to a sufficient size as described in further detail below with regard to the prioritization matrices.

Turning to FIG. 10C, for each of identified crop plants 1704 and/or each of the

identified weeds 1706, a probability score may be calculated or determined in a primary and/or a secondary processing engine of the AI framework 292. The algorithms may involve semantic segmentation, instance segmentation, and/or object detection as previously described. The output of the secondary processing engine may comprise a confidence interval, and/or pixel mask, and/or bounding box for each of the identified crop plants 1704 and/or each of the identified weeds 1706.

GPS or other geolocation coordinates may also be appended to each crop plant 1704 and/or each identified weed 1706 in order to be located in the future. For example, an image containing one or more plants 1704 may be passed through the AI framework 292 that has been previously trained to identify canola plants. The output from the AI framework 292 may correspond to one or more probability or confidence that each respective crop plant 1704 is a canola plant. In practice, the confidence may range from 0 to 100%. In another example, the identified weed 1706 may be passed through the AI framework 292 in order to determine a probability or confidence that the identified weed 1706 is indeed a weed. Therefore, each of the identified crop plants 1704 and/or each of the identified weeds 1706 may have an associated confidence. Although described herein, the targets have been identified prior to determining a confidence, other aspects may identify the targets and the associated confidence simultaneously by the AI framework 292.

Although each of the identified crop plants 1704 and/or each of the identified weeds 1706 may have an associated confidence, problems may occur during spraying. Even when the AI framework 292 may be trained to provide very high accuracies, such as 99%, this accuracy results in roughly one out of every 100 weeds not being treated in the field. Over a large field, this accuracy may leave hundreds or thousands of untreated weeds. A risk exists that these untreated weeds may proliferate and/or damage the crop. Moreover, overtraining the AI framework 292 may result in an inflexible framework that may be unable to adapt to different plants and/or weeds at different stages.

In the case of herbicide application, low accuracy may result in a mis-categorization of a plant (e.g., erroneously identifying a weed as a crop, or vice versa), a misidentification of a species, missing the plant entirely (e.g., not detecting a plant as a plant at all), and/or detecting an object that is not a plant (e.g., an odd-shaped rock) as a plant. Similar problems arise for other types of pest control such as herbicide, fungicide, or even fertilizer application. The low accuracy may lead to underuse or overuse of chemical applications or misapplication of the wrong chemical, causing damage to the crop and/or ineffective treatment.

Problems may also occur with chemicals that may be designed to be applied at certain times. Merely using a probability of plant phenotype may result in the operator being unable to cater the treatment system to plants of different stages. An ability to ignore plants of different stages provides farmers with a superior level of control. A solution using chlorophyll or infrared sensors is not capable of differentiating plant stages, and relying on artificial intelligence systems may have the same probability problem described above.

In one aspect, a graphical user interface or interface may present one or more dials and/or sliders in order to adjust one or more priority parameter of at least one priority matrix. The priority parameter may be adjusted to indicate at least one of: (a) a plant stage or range of plant stages to target, and/or (b) a minimum probability to execute a treatment operation. When the parameter adjustment is set to a lowest setting, a broadcast spray application may be performed by the treatment system 250; at the next lowest setting, all plant life (e.g. crop plants 104 and/or weeds 1706) may be selected for spraying by the treatment system 250; at the next lowest setting, all plant life that is not crop with a confidence >95% could be sprayed; at the next lowest setting, all plant life that is not a crop with a confidence >90% could be sprayed, and so forth. When the parameter adjustment is set to a maximum setting, only weeds with a 99% confidence interval or greater would be sprayed. This parameter does not need to be discrete, but may also be continuous. The parameter adjustment may adjust a plant species, a minimum or maximum confidence interval, a plant stage, and/or any combination thereof; and may comprise multiple parameters. For example, in addition to, or instead of, plant type, a secondary set of tensors may provide an ability to target plant stage. When set to a widest range, all plants may be sprayed. When a lowest tensor is set to a specific plant stage, only plants of that stage or later are sprayed. When a highest tensor is set to a specific plant stage, only plants of that stage or younger are sprayed. When both the lowest and the highest tensors are set, only plants after a specific stage but younger than another stage may be sprayed. The priority parameter adjustment may provide the farmer and/or operator with a simple selection method to control the treatment system 250 to align with their priorities.

The parameter adjustment system may permit the farmer or operator to adjust desired farming outcomes through a set of progressive variable heuristics that may compensate for one or more inherent probability errors in the AI framework 292. The spray operations may be customized based on thresholds defined within the priority matrices. The farmer or operator may also adjust which priority matrices may be applied and/or may change the priority matrices during operation of the treatment system 250.

One example of a priority matrix may be a Maximum Chemical Savings matrix in order to minimize an amount of chemical applied during treatment. The maximum chemical saving matrix may treat only plants detected as a weed with a very high confidence threshold (e.g., 99%). Any weeds with a confidence lower than the high confidence threshold may be ignored and may be untreated. The maximum chemical savings matrix may leave a greater percentage of untreated weeds in the field, but achieves a benefit of less chemical use and/or faster speeds.

In another example of the priority matrix may be a Maximum Weed Control matrix in order to treat a high number of weeds. The maximum weed control matrix may treat any identified plant that is not detected as a crop with the very high confidence threshold (e.g., 99%).

Any plants with a confidence lower than the very high confidence threshold would be treated. When the maximum weed control matrix is applied, crop plants with low confidence may be treated as well as non-weeds such as rocks (that have been misidentified as plants). This may be wasteful as excess spray may be delivered, but will leave less untreated weeds on the field.

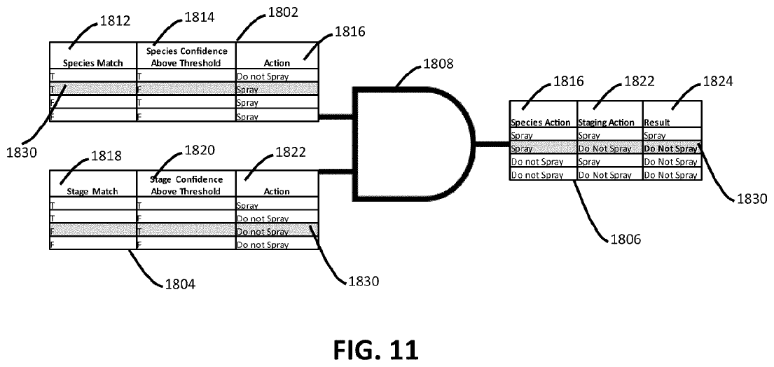

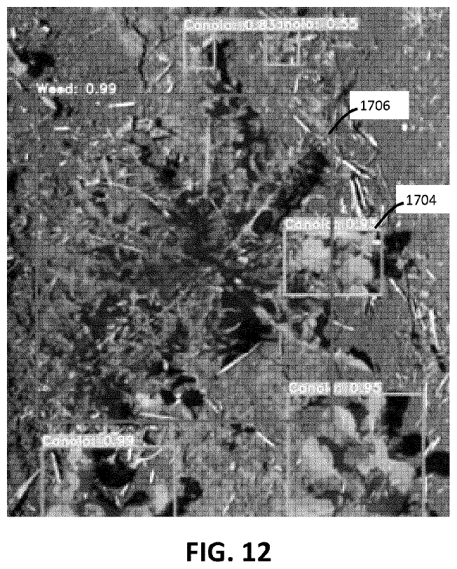

Turning to FIG. 11, the priority matrices 1802, 1804, 1806 may each represent

different parameters that may be translated into a decision tree for a quantized spray application. Multiple priority matrices 1802, 1804, 1806 may be chained together to be applied in sequence and/or in parallel, and passed through a logical AND gate 1808 to create combinations of decisions that may result in an execution of granular priorities based on one or more tensors contained within each matrix. Although FIG. 11 presents three priority matrices 1802, 1804, 1806 chained together, other aspects may comprise more priority matrices chained together in a similar manner with each priority matrix associated with a different priority.

As shown in FIG. 11, a species identification matrix 1802 and a plant stage matrix 1804 may be passed through the logical AND gate 1808 to form a resulting priority matrix 1806 that considers species and stage in order to determine a spraying action. The species identification matrix 1802, shown in Table 1, comprises a species match 1812 and a species confidence above a threshold 1814 in order to determine whether a spraying action 1816 is to be performed.

TABLE 1

| “Crop” Match | Confidence >90% | Action |
|---|---|---|
| T | T | Do not Spray |
| T | F | Spray |
| F | T | Spray |
| F | F | Spray |

Similarly, the plant stage matrix 1804, shown in Table 2, comprises a stage match 1818 and a stage confidence above a threshold 1820 to determine if a spray action 1822 is to be performed. As a result of the logical AND gate 1808, the resulting priority matrix 1806 shows the species action 1816 and the staging action 1822 to produce a result 1824. The matrices 1802, 1804 may be run in sequence or in parallel depending on hardware implementation. As mentioned previously, one or more sliders or dials may adjust a confidence threshold for one or more of these priority matrices either independently or simultaneously.

TABLE 2

| Stage Match | Confidence >80% | Action |
|---|---|---|
| T | T | Spray |
| T | F | Do Not Spray |
| F | T | Do Not Spray |
| F | F | Do Not Spray |

In an example using a species identification matrix 1802 and a plant stage matrix 1804, the farmer may want to spray only broadleaf weeds that have progressed past a four-leaf stage. In this case, a plant class matrix, such as matrix 1802, and a stage matrix, such as 1804, may be applied. The plant class matrix 1802 may be configured to identify crop plants with a confidence interval in excess of the threshold of 90% and anything not falling into a crop plant may be sprayed or treated. The plant stage matrix 1804 may be configured to select plants after the four-leaf stage with a confidence interval of 80%. This would result in the two matrices shown in Tables 1 and 2.

Using an example, a plant is identified in the image data and the AI framework 292 identifies that plant as “crop” with a 40% confidence. The AI framework 292 also identifies the plant stage as a two-leaf stage with 98% confidence. These criteria would select the shaded priority matrix chain 1830 shown in FIG. 11. In this priority chain 1830, the species match 1812 is found, but not at a high enough confidence 1814, so the priority chain for “species” is to perform the spray action 1816 in the species identification matrix 1802. However, the plant stage 1818 is not at the correct stage required in the plant stage matrix 1804, with high confidence 1820, which generates a do not spray directive 1822. The logical AND operation 1808 on both priority matrices 1802, 1804 results in a final action 1824 of do not spray.

Matrices 1802, 1804 may be processed sequentially or in parallel using logical

gates, or as one large action matrix shown in Table 3.

TABLE 3

| | Species | | Stage | |
|---|---|---|---|---|
| | Confidence | | Confidence | |
| Species | Above | Stage | Above | |
| Match | Threshold | Match | Threshold | Action |
| T | T | T | T | Do not Spray |
| T | T | T | F | Spray |
| T | T | F | T | Do not Spray |
| T | T | F | F | Spray |
| T | F | T | T | Spray |
| T | F | T | F | Spray |
| T | F | F | T | Do not Spray |
| T | F | F | F | Spray |
| F | T | T | T | Spray |
| F | T | T | F | Spray |
| F | T | F | T | Do not Spray |
| F | T | F | F | Spray |
| F | F | T | T | Spray |
| F | F | T | F | Spray |
| F | F | F | T | Spray |
| F | F | F | F | Do not Spray |

Although the matrices presented herein demonstrate binary inputs, other aspects may have nonbinary inputs. For example, a matrix where plant species and plant stages may be generalized into a single parameter.

5 In yet another example of a priority matrix may be applied to situations where

spraying weeds may inevitably result in spraying the crop. For example, as shown in FIG. 12, in the event that the crop 1704 and the weed 1706 are overlapping or otherwise too close together the farmer may decide to ignore those weeds 1706 to avoid damaging the crop 1704, or may spray those weeds 1706 and assume the risk of damaging the crop plant 1704. An overlap matrix as shown in Table 4 may be applied in these instances.

TABLE 4

| | | Overlapped weeds | |
|---|---|---|---|
| Stage Match | Stage Confidence | and crop? | Action |
| T | T | T | Spray |
| T | T | F | Do not Spray |
| T | F | T | Spray |
| T | F | F | Spray |
| F | T | T | Do not Spray |
| F | T | F | Spray |
| F | F | T | Do not Spray |
| F | F | F | Spray |

There is no limit to the amount or number of parameters provided the matrices

follow a logical sequence of outcomes.

As mentioned, one or more requirements of the farmer may change from crop to crop, field to field, season to season, etc. Agriculture is considered to be a time-sensitive, a cost- sensitive, and an environmentally sensitive operation. For example, the farmer might be concerned with saving chemicals, but when a string of bad weather impacts a spraying window, the farmer may reduce the chemical saving priority in order to complete treatment of the field to be within the spraying window available. Likewise, the farmer may start a spraying operation, but midway through the operation, inclement weather arrives, and the farmer needs to complete the job much faster.

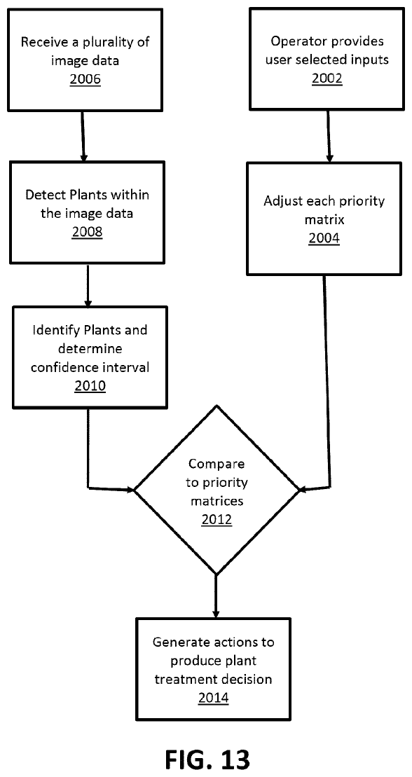

By adjusting the priority matrices in real-time via software or hardware, the farmer may choose to adjust outcomes in real-time. Turning to FIG. 13, a flowchart presents a number of steps that may be involved in adjusting priority matrices in real-time during operation. The farmer may provide user selected inputs 2002 using a user interface presented on a computer display (not shown). The user selected inputs may control the plant staging (cotyledon) and/or chemical savings. These inputs may be performed on a global basis (e.g., any plant), a general basis (weed versus crop), and/or a specific basis (e.g., a list of weed species and a confidence interval and/or plant staging). These user inputs may dynamically configure and/or control one or more aspects of each priority matrix. At step 2004, adjustment of the user inputs may adjust a confidence interval for one or more of the priority matrices and/or may adjust a binary or a trinary segmentation (weed 98%, crop 2%, background 10%), a species level identification, and/or plant staging (cotyledon, etc.).

During operation, a plurality of image data 2006 may be received from the one or more cameras as described herein. The AI framework 292 may process each of the plurality of image data 2006 in order to detect one or more plants at step 2008. The algorithms may be as previously described but may include semantic segmentation, instance segmentation, and/or object detection. At step 2010, the AI framework 292 may further identify plants and determine a confidence interval for each of the detected plants. An output of step 2010 may provide a confidence interval, a pixel mask, and/or a bounding box for each of the identified plants. GPS coordinates may also be logged to a database of each identified plant in order for the plant to be located again the future.

A comparison 2012 may be made for each identified plant to each priority matrix.

This comparison 2012 may involve providing a plant type and the confidence interval to the thresholds identified in the priority matrix. The output of this comparison may generate a single action per category as previously described with reference to FIG. 11. These actions may then be passed through the logical AND gate as previously described to create a final hierarchies of treatment priorities at step 2014. The process in FIG. 13 continues to repeat until the farmer terminates the treatment system 250. The treatment priorities may then be processed by the targeting system 292 to perform the appropriate treatment.

It may be noted that although the process in FIG. 13 has been described as a real- time process, steps 2006 2008, 2010 may be performed and stored. The farmer may then load the resultant data from these data collection and identification steps into an offline system in order to simulate adjustment of the priority matrices to produce the treatment priorities for the targeting system 292 to be performed at a later date.

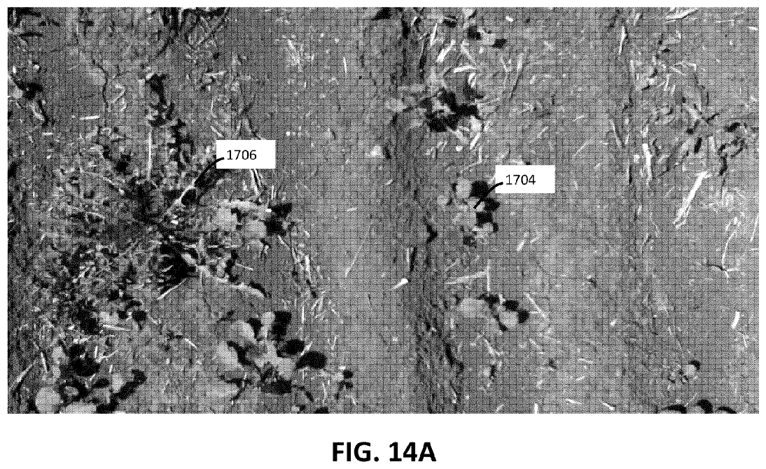

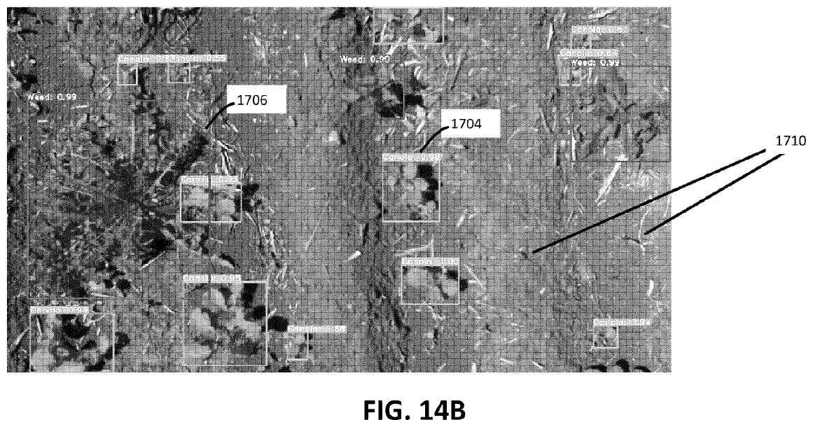

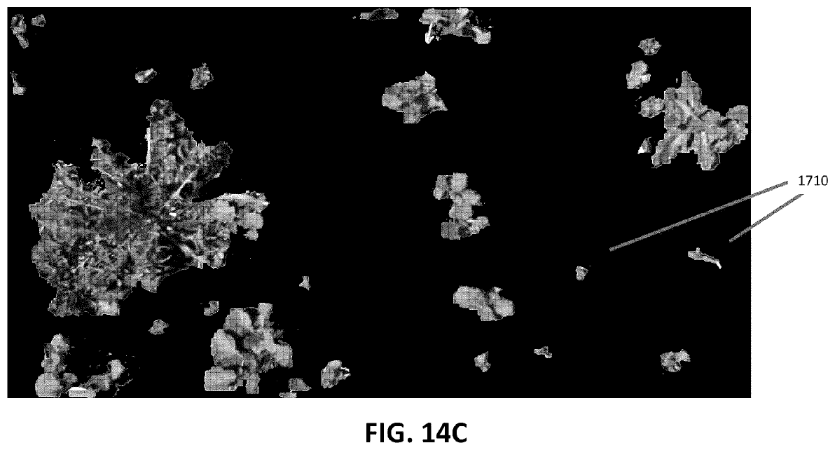

As described herein, the artificial intelligence system 292 may detect all or substantially all of the plants in the field. When the AI framework 292 is unable to reliably detect plants correctly as plants, an inefficient or undesirable outcome may occur converse to the priorities specified by the farmer using the graphical user interface. As presented in FIGS. 14A- 14C, one optimization to the accuracy of the AI framework 292 may be to combine AI framework 292 with secondary vegetation detection module applying methods and/or image processing techniques to ensure all plants are adequately detected in the field prior to application of the AI framework 292. In FIG. 14A, an example image of a section of field is presented showing weeds 1706 and crop plants 1704. The AI framework 292 may perform a plant detection on the image as shown in FIG. 14B; however, the AI framework 292 has failed to identify two weeds 1710 that are below a threshold size. When the secondary vegetation detection method is applied, as shown in FIG. 14C, the missing weeds 1710 may be more clearly visible. By combining the map in FIG.

14B with the vegetation map shown in FIG. 14C, refined accuracy of the treatment system may be achieved.

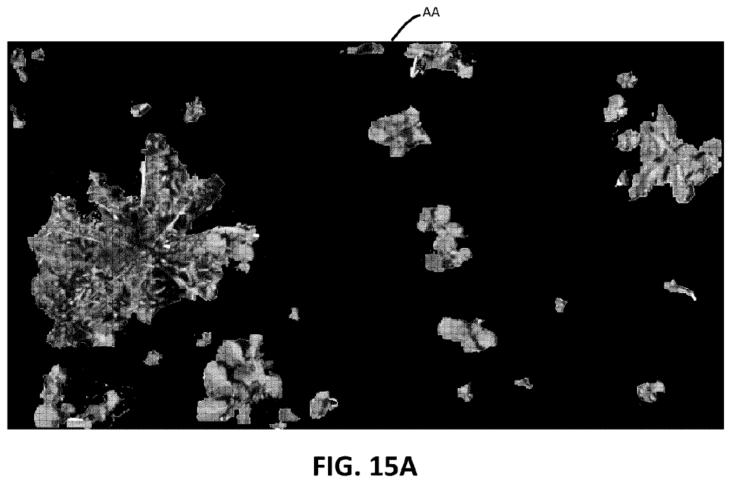

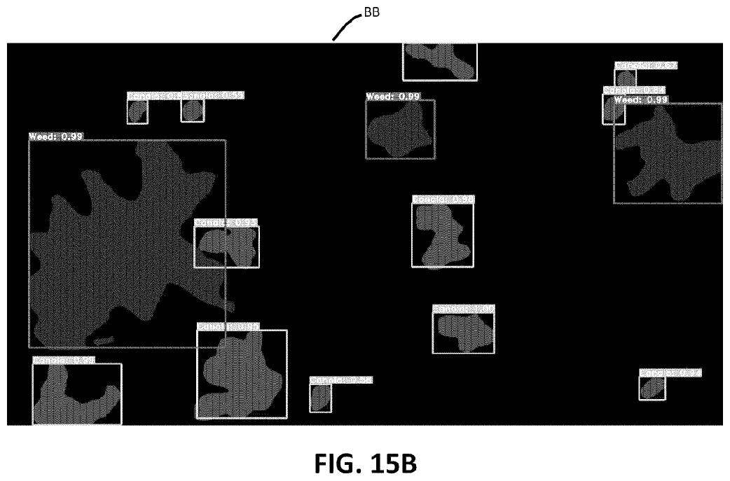

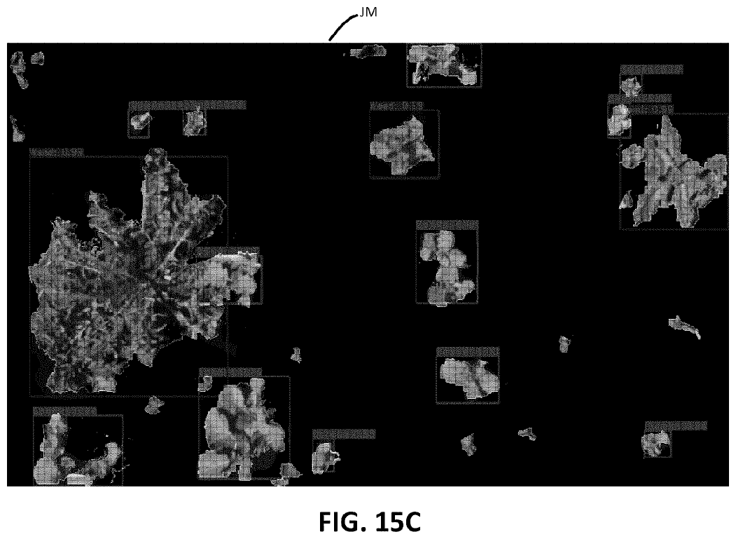

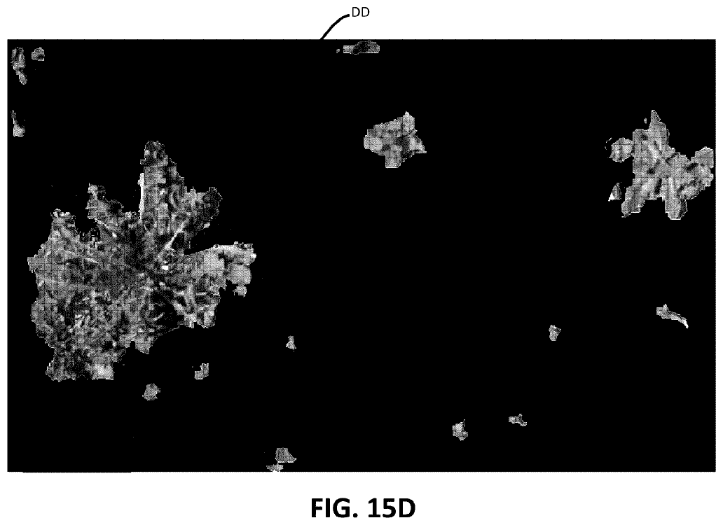

In one aspect, a green detection process 2008, or a chlorophyll/vegetation detection process, or other heuristic may locate one or more positions of all pixels in the image data representing possible vegetable/plant life. The green detection process 2008 may create a vegetation map (AA) shown in FIG. 15A. Sequentially, or in parallel, a classification system 2010 of the AI framework 292 may detect the plants in the image data and/or identify the plant type and stage in a plant type and stage map (BB) shown in FIG. 15B. The vegetation map (AA) may then be combined with the plant type and stage map (BB) to produce a joint map (JM) shown in FIG. 15C. Zero or more Priority Matrices (ZZ) may be applied to the output (BB), such as at step 2012, to develop a target output map (CC) containing a list of targets that should be sprayed.

The resulting outputs (CC) may contain zero or more plants, for example crop, or plants outside of the correct staging, that should not be sprayed. By performing a NAND function between a region of the plants (either pixels or bounding polygon) of (CC) with the vegetation map (AA), generates a treatment output map (DD) where DD =AA A CC, where A is a NAND function, comprising all vegetation detected excluding regions that should not be sprayed. An example treatment output map (DD) is shown in FIG. 15D.

In another aspect, zero or more Priority Matrices (ZZ') may be applied to the output (DD) to further refine the results into another output (EE), where EE =ZZ'(DD), comprising all vegetation minus the areas that should not be sprayed, adjusted for one or more additional priorities defined in ZZ'.

Although the priority matrices described above relate to treatment of weeds, other aspects may use a similar process for fungicide treatment, insecticide treatment, and/or fertilizer treatment as presented in Table 5 below.

TABLE 5

| Treatment | | | | |
|---|---|---|---|---|
| Type | Parameter 1 | Operator | Parameter 2 | Result |
| Herbicide | Vegetation | NAND | Crop Region | Plant life that |
| | Region | | | is NOT crop |
| | | | | would be sprayed |
| Fungicide | Vegetation | AND | Crop Region | Plant life that |
| | Region | | | IS crop would be |
| | | | | sprayed, other |
| | | | | plant life would |
| | | | | not be sprayed. |
| Insecticide | Insect | GREATER | Minimum | Insect region |
| | Region | OF | Treatment | widened by |
| | | | Region for | recommend |
| | | | Infestation | treatment area, |
| | | | Type | regardless of |
| | | | | plant life. |
| Fertilizer & | Vegetation | AND | Greater of Crop | Fertilize the |
| Organics | Region | | Region or | crop and |
| | | | minimum | surrounding |
| | | | treatment region | area |
| | | | for fertilizer type | |

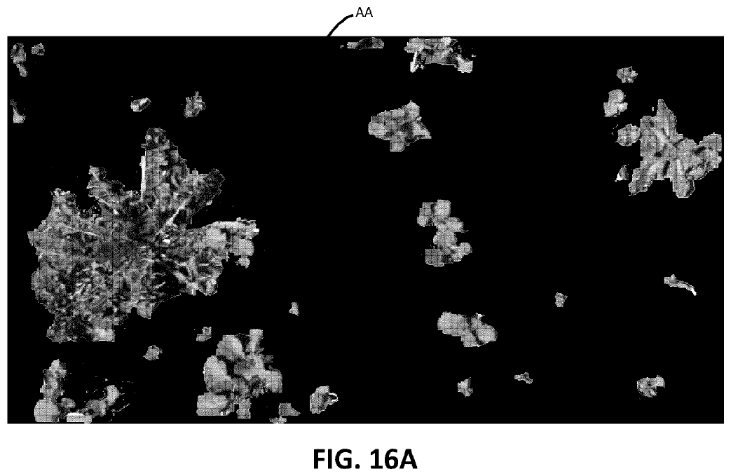

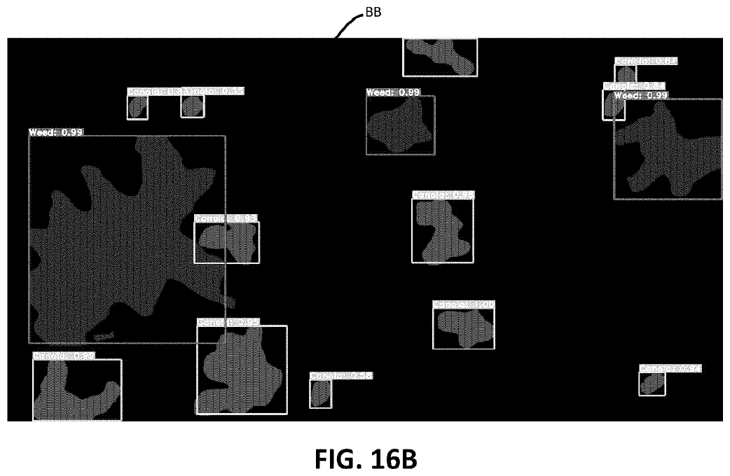

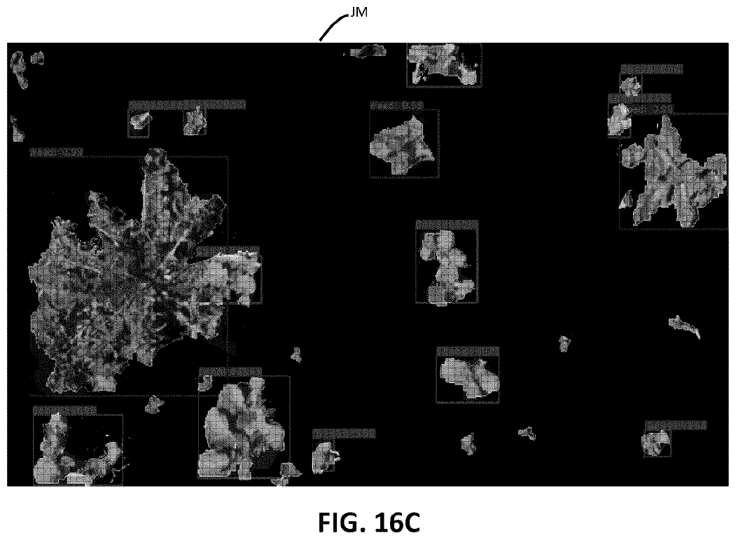

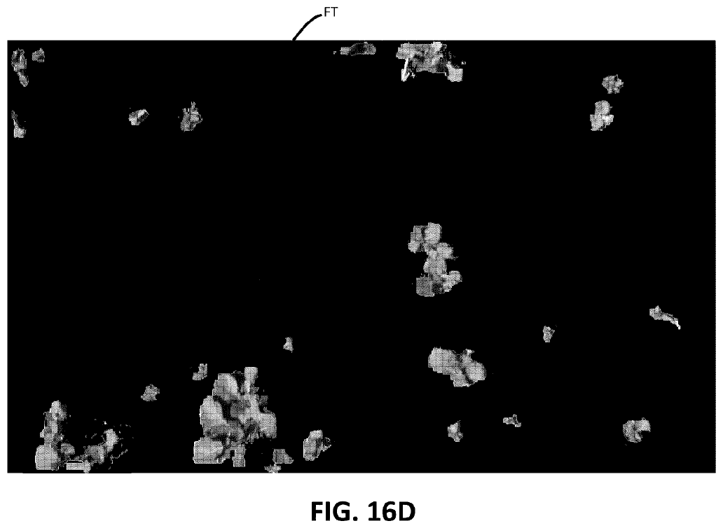

Turning to a fungus treatment aspect, the green detection process 2008 may be similar to the green detection process 2008 previously described to produce the vegetation map (AA) shown in FIG. 16A. Similarly, the AI framework 292 may generate the plant type and stage map (BB) shown in FIG. 16B. The vegetation map (AA) may then be combined with the plant 10 type and stage map (BB) to produce a joint map (JM) shown in FIG. 16C. The fungicide treatment output map (FT) shown in FIG. 16D may then be determined by FT =AA A CC, where A is an AND function. An AND function is performed which would instruct the fungicide to be applied only to crop plants. A further set of priority matrices tuned to fungicide application could be

provided similar to [0096]. For example, a priority matrix could modify the output to apply fungicide only to crop where fungus is visibly present within a certain confidence interval, or applying fungicide to all plants within a specified threshold distance of a presumed infected plant.

Turning to an insecticide treatment aspect, a pest detection process may be used.

For example, if the insects have a predominant colour, such as red, then the image data may be filtered for that colour in order to determine a quantity of insects present in the image data. The priority matrix may then determine a threshold parameter associated with a quantity of insects present in the image data to determine if treatment should occur. As the insecticide may not impact the plant life, an insect region may be expanded by an expansion process based on the number of insects present in one or more images regardless of the plant life detected.

The targeting system 292 may include a target verification subsystem. If the targeting system 292 determines the object is a target or likely to be a target, the object is flagged as such and sent to the target verification subsystem. The target verification subsystem uses the mission rules and the object data from the data collection system 848 and algorithms to verify that the object is a target to be sprayed. The target verification subsystem is used as a final check that the object is to be sprayed according to the mission rules. The target verification subsystem may add the object to the target list or flag the object as the obstacle, or a non-target, or the object to be ignored, or as a target to be included in another mission. The target verification subsystem may be implemented as one or more priority matrices.

The target verification may determine if the identified potential target is to be

sprayed by the drone 202, 600. The target verification may involve additional analyses of the same images/sensor data already collected by the drone 202, 600 and/or another drones 202, 600. The target verification may involve analyses of additional image data and/or sensor data. The target verification rules may be based on the configuration of the drone 202, 600, the resources of the drone 202, 600 remaining at the time of verification, the mission priorities in effect at the time, and/or other criteria. The verification rules may also involve the probability that the target has been accurately identified. The verification rules may also involve the confidence level that the spray will reach the target in a sufficient dosage. The verification rules may also involve the probability of an over spray or an under spray. The verification rules may also involve the probability that non-targets may be sprayed as the spray vector hits the desired contact area. The object detection, the target identification, the target verification, and the determination of the desired contact area may be performed in a single step or in two or more separate steps or as a series of iterations of one or more steps.

In some aspects, the target verification may comprise image registration and/or geocoordinate registration whereby the previously captured sensor data of the target and/or geocoordinates may be saved and compared to the newly captured sensor data. For example, a matching two photos of the same target plant at different times, which might be slightly different (e.g., different angle, different position in photo, moved by wind, etc.). The image registration and/or geocoordinate registration may ensure that multiple passes do not spray the same target plant more than once or may be used to determine a health of the target plant in order to determine if a more effective treatment may be necessary.

The techniques for object detection, target identification and verification, may also be applied to gathering data for target prioritization such that the same or similar image and sensor data is used. Examples of the target prioritization include rules that prioritize the targets that are dropping or ready to drop seeds, targets that are larger, targets that are closer to or further away from non-targets, targets of a particular variety over another variety, targets with desirable orientation relative to the drone 202, 600, targets with higher identification confidence, targets with higher hit confidence, etc., or any combination thereof.

The targeting system 292 may include a target prioritization subsystem like the

priority matrices as previously described. The prioritization subsystem processes the verified target list to optimize the grouping and sequence of the verified target list according to the mission rules. The prioritization subsystem processes the target list including target information and target tracking data, to determine if there are targets that should be grouped together and the relative order or sequence in which the targets should be sprayed. If the drone 202, 600 includes multiple spray nozzles 720, the prioritization subsystem assigns a specific nozzle 720 to the target or the group of targets. If the prioritization subsystem creates a target group, then spray vector computation subsystem may give the target group a single, contact area, center point, and/or spray vector for that target group. The prioritization subsystem acts as a mission optimization frontend for the spray vector computation subsystem by adjusting the target list received by the prioritization subsystem to create a second target list that is the input to the spray vector computation subsystem. Thus, the spray vector computation subsystem achieves resource efficiencies by having a predetermined target order that optimizes the timing of each spray relative to the time and resources required for each spray vector calculation. The spray vector computation subsystem also achieves resource efficiencies by calculating fewer spray vectors because of the target groupings.

As described above, the prioritization subsystem may potentially reformulate the

second target list based updated information from the data collection system. For example, the data collection system may detect target movement that changes the relative location of the target such that the target sequence is adjusted, or the target is removed from the target list such as when the target has moved or is expected to move out of range as dictated by the mission rules.

In one aspect, the data gathered by the drone 202, 600 regarding the environmental and other local conditions may be used to modify the prioritization matrices for the drone 202, 600 or one or more drones 202, 600 by relaying the data from to the base station 300 or directly to the one or more drones 202, 600. For example, a local micro topography and wind data may be used to modify the priority matrices. As a further example, one or more non-target plant characteristics in a row or section may create a wind pattern that may be different from other rows or sections in that shorter or less dense non-target plants may not block the wind. In such a circumstance the spray vector may be affected to a greater degree in these rows compared to other rows or sections. Such variations may be accommodated by modifying the priority matrices and/or modifying the spray vector algorithm. Further the conditions of the drone 202, 600 and the components 800 may be used to modify the priority matrices such as a life of the battery 708, the amount of spray remaining, the achievable spray pressure, etc. Further, a complete or partial failure of a drone component 800 may be the basis for modifying the priority matrices or the spray vector algorithm. For example, a lower than expected tank pressure resulting from a pump problem or a leak in the spraying system 700 may cause a modification. Similarly, a partial or total failure of the camera 830 and/or the sensors 806 may cause the priority matrices modification.

In one aspect, the drone 202, 600 may use the image data and/or the sensor data to

determine how effectively the target was sprayed. For example, the image data and/or the sensor data may determine that the moisture on the target plant after being sprayed is less than desired or more than desired. The determination may be used to modify the priority matrices and/or the spray vector algorithm.

For each target to be sprayed, the targeting system 292 may calculate a spray vector. The spray vector may include a specific position and orientation for the spray nozzle 720, a precise spraying time and duration, a spray geometry, a spray pressure, a distance between the spray nozzle 720 and the desired contact point at the spray time, a time required for the spray to travel from the spray nozzle 720 to the desired application area, etc. The spray vector may be calculated to aim a tip of the spray nozzle 720 and a tip vector of the nozzle 720 to spray a specific spray contact area such as a portion of the target to optimize the treatment objectives within the mission rules. For example, the spray vector may aim for a base of the target plant or a leafy area, or the entire target, or the head or the body or another portion of the target. The spray vector calculation may include a number of factors including a relative speed and heading of the drone 202, an inertia of the drone 202, 600 and the spray nozzle 720, a relative stability and vibration of the drone 202, 600 and the spray nozzle 720, a time lag from the spray command to the spray initiation, one or more environmental conditions such as humidity, wind, and rain, a dampness or dryness of the target, the size of the target and the identified contact area, an aerodynamic drag of the spray and wind effects on the spray travel, an effect of gravity, the size of the desired target contact area, one or more available spray pressure(s) and geometry(s), a velocity of the spray leaving the spray nozzle 720, an anticipated movement of the target, a proximity of non-targets, and any other factor relevant to mission success. A priority matrix may be associated with one or more of these environmental conditions in order to adjust the treatment priority.

The number of factors used in calculating a spray vector affects the complexity of

the calculation and thus the computing resources 802 and time required for the calculation.

Similarly, each factor may be a variable that introduces uncertainty in the spray vector calculation. The uncertainty may be used as a probability of a successful spray and the probability may be used to modify the spray vector to increase the probability of a successful spray. The probability calculation may include such results as the probability of affecting a non-target, or not applying the desired amount of spray to the desired contact area. In response to probability calculations the drone 202, 600 may for example, increased or decrease the number or the boundaries of desired contact areas. The probability calculations may affect one or more of the priority matrices. The probability calculations may be combined with ongoing or intermittent scoring of how successful past sprays have been. In some aspects, the drone 202, 600 may adjust the velocity of the drone 202, 600 by reducing power to the motors 810 so that the spray may be more accurate and thereby more successful.

The targeting system 292 may include a first predictive analysis subsystem 822 directed to implementing a triage type analysis to quickly and efficiently disposition objects that can be identified with fewer computation resources 802 while flagging those objects that require more computational resources 802 to distinguish for further processing. The first predictive analysis subsystem 822 may make object type determinations using fewer computational resources 802 and less computational time where possible. One purpose of the first predictive analysis subsystem 822 may be to use less computational time and resources 802 to quickly and efficiently distinguish targets and potential targets from everything else and flag those objects to the target identification system for further processing. The first predictive analysis subsystem 822 may be to use less computational time and resources of the processor 802 to quickly and efficiently distinguish objects that should be ignored from everything else and flag those objects as objects to be ignored. The first predictive analysis subsystem 822 may be to use less computational time and resources to quickly and efficiently distinguish obstacles from everything else and flag those objects to the drone navigation system 808. The first predictive analysis subsystem 822 may be to use less computational time and resources of the processor 802 to quickly and efficiently distinguish non-targets that are not located near objects identified as targets or potential targets or objects that require further processing and are less likely to be affected by overspray and therefore not included in an overspray calculation.

The targeting system 292 may include a second analysis subsystem. The second analysis subsystem may be designed to perform object type determinations on objects not dispositioned by the first object identification subsystem. The second analysis subsystem may be designed to use additional data and/or more computational resources to perform object type determinations than were allocated to the object by the first object identification subsystem.

As previously described with regard to the first and the second analysis subsystem, this may be extended to the targeting system 292 having a series of object identification subsystems each directed to using greater computational resources and more computational time than the preceding object identification subsystem. The series of object identification subsystems may allow the targeting system 292 to manage computational time and resources to only apply the greatest computational time and resources to those objects that are not dispositioned using less computational time and resources. Each object identification subsystem may provide processed data and computational results to the next object identification subsystem until the mission rules are satisfied regarding object disposition. This allows the targeting system 292 to direct the data collection system 848 to gather more data if needed based on the mission rules and to optimize computational resources and power resources to be used as needed. The mission rules may specify that not all objects need to be identified and dispositioned and may contain rules that allows the data collection system 848 or the targeting system 292 to ignore objects or classes of objects while only gathering minimum data and performing little or no object dispositioning.

In one aspect, the drone 202, 600 comprises one or more steps of detecting multiple objects, identifying, verifying, and/or prioritizing multiple targets, calculating multiple spray vectors, determining the success of multiple sprays and using the spray success determinations as an input to subsequent spray vector calculations. One skilled in the art will understand that these systems, subsystems or portions thereof used to perform these steps, can be combined, used in a different sequence than described herein. In some aspects, simplified and in some implementations omitted to achieve a less complex and/or less resource intensive design.

The targeting system 292 includes a target contact area computation subsystem.

The target contact area computation subsystem includes the contact area center point computation subsystem. The contact area computation subsystem uses mission rules, spray chemical composition, target data from the data collection system 848 and target identification data to calculate the size and/or orientation of the target relative to the drone 202, 600 and/or one or more possible positions of the nozzle 720. The drone 202, 600 and/or one or more possible positions of the nozzle 720 may be estimated at the estimated time of the spray command being initiated using data from the drone navigation system 808, and the drone mechanical status system (not shown) and the target location data. The target location data may be known from the target data collection subsystem or estimated by the moving target computation subsystem as previously described. The contact area computation subsystem may calculate the contact area to define one or more geometric 2-D or 3-D boundaries. The contact area may be calculated to optimize the mission objectives, for example, to kill an identified weed or an identified pest with the smallest reasonable amount of spray necessary. For example, if the target is a plant, the contact area may include one or more leaves, a stalk, a base, an area around the base, or any combination thereof. The contact area may be calculated to maximize the sprays absorption into the target or into the earth surrounding the target. The contact area may be calculated to concentrate the spray on the body of a pest or an area surrounding the pest but including the pest. The contact area may be calculated to concentrate the spray on a head, face or eye of a pest such as a mouse or other unwanted living creature. The contact area geometry may be an input to the spray vector computation subsystem.

The contact area computation subsystem may calculate a contact area center point using a center point computation subsystem. The calculated contact area and center point are reference points to be used by the spray vector computation subsystem for calculating the spray vector for the target. The center point may be calculated based on the contact area geometry and spray vector variables selected to simplify the spray vector calculation. For example, the center point may be calculated based on the spray geometry and the estimated target range at the time the spray command is estimated to be issued. The center point may provide an aiming reference point used by the spray vector computation subsystem for calculating the spray vector and factoring the uncertainties and probabilities of the moving drone 202, 600 to aiming the nozzle 720 at the stationary or moving target in the environment that includes wind data and non-targets to be avoided. For example, the spray vector computation subsystem may center the centerline of the spray geometry on the target center point.

The contact area computation subsystem may calculate an amount of spray to be deposited on or within the contact area to achieve the mission objectives for the specific target.

For example, the amount of spray to be deposited may be determined by the desired effect on the target, the target characteristics, and the chemical composition of the spray, and current environmental conditions, such as wind or moisture.

The targeting system 292 may include a spray vector computation subsystem. The spray vector computation subsystem may calculate the spray vector command set. The spray vector command set may be a set of commands issued to the drone to instruct the drone 202, 600 to execute the spraying of the individual target or the cluster targets. Each spraying event may have an associated spray vector command set. The spray vector command set may include at least the positioning of the drone 202, 600 and at least one spray nozzle 720 and may include the timing of the spray on command to initiate the spray and the timing of the spray off command to stop the spray. The spray vector command set may also include commands to change the position of drone 202, 600 and or the spray nozzle 720 on the drone 202, 600 to achieve the desired distance and orientation of the nozzle tip 720 relative to the target, the spray geometry, and may also include the movement of the spray nozzle 720 and drone 202, 600 before, during, and/or after the spraying process.

The spray vector computation subsystem may use a variety of factors, inputs and calculations to determine the spray vector for each spraying event in accordance with the mission rules. These factors, inputs and calculations may include the contact area geometry and the center point, the motion vector of the nozzle tip 720 and the expected spray momentum and inertia, the uncertainties and probabilities introduced by the movement and vibration of the drone 202, 600, the localized wind effects, the spray chemical characteristics including its specific weight, dispersion characteristics, and anticipated aerodynamic drag, gravitational affects, and target movement trajectory, probabilities and uncertainties (if any). The spray vector computation subsystem may use a continuous best fit analysis to continually refine the spray vector command set and/or contact area(s) boundaries and center points. The spray vector computation subsystem may calculate the spray vector command set once, twice, or multiple times based on a predetermined schedule or based on a material change in one of the factors used to calculate the contact area or the spray vector.

The targeting system 292 may provide to the spray vector computation subsystem data and rules regarding non-targets. The spray vector that results in the spraying of non-targets may be undesirable or extremely undesirable. Thus, non-target spray avoidance may be a high priority even to the point of the spray vector computation subsystem flagging the target as off- limits for this mission and thus not issuing a set of spray vector commands. The proximity of the non-target to the target may also affect the calculation of the desired contact area(s) for the target. The contact area(s) may be calculated to be located less proximate to the non-targets even though the resulting contact area(s) may be less desirable and more difficult to hit with the pray vector.

As before, a less optimum contact area as related to a volume intersection (hereinafter referred to as the V-INT) as discussed herein may result in the target being flagged as off limits and not to be sprayed at this time under these conditions. For example, the target flagged as off limits for this mission may be sprayed successfully during a future mission when the wind may be less of a factor or other factors may be less of an issue regarding overspray. The overspray of non-targets may be such a priority that the same or greater methods and rigor as described herein to achieve a successful spray may be used to avoid an overspray of a non-target.

The targeting system 292 may include a non-target avoidance subsystem that can override the spray vector computation subsystem. In the same or similar way, a target contact area may be calculated as an input to the spray vector computation subsystem. The non-target avoidance subsystem may calculate an avoidance area with one or more avoidance boundaries and/or a probability of avoidance of the non-targets referred to herein as Pavoid. The spray vector computation subsystem may use a Pavoid calculation is a similar way it uses a Pspray calculation to refine and finalize the spray vector for a target and the resulting spray vector command set. A Pavoid may have an acceptable range of values similar to the Pspray and may be designated by the mission rules as a more important, less important or equally important result relative to Pspray such that Pavoid may be an overriding mission objective.

To execute the spray process, the spray vector computation subsystem may

generate commands that the targeting system 292 sends to the drone navigation system 808 and the drone mechanical system 850 to adjust the drone's pre-spray state to the desired spray state including the current drone velocity and orientation relative to the target and to direct servo motors 810 to drive the spray arm 622 orientation and the spray nozzle tip 720 orientation, including adjusting the nozzle tip 720 to control the spray geometry in order to match calculated spray vector components.

These mechanical and navigational adjustments may have a certain amount of time delay to reach the commanded state. The spray vector may be updated intermittently or continuously during this time delay and the orientation commands may be intermittently or continuously updated so that the drone 202, 600 may be continuously aimed at the most recent spray vector target point. The target identification, verification, and prioritization subsystems may continue to update their respective inputs to the spray vector computation subsystem and the spray vector calculation may be updated based on new camera and/or new sensor data, and other relevant data received during the time delay for the drone state change.

The targeting system 292 initiates a spray on and spray off command to the spray

nozzle vector control system to execute the spray and control spraying by the drone 202, 600. The entire process may be conducted simultaneously or near simultaneously for the next prioritized targets using different spray nozzles 720 or the same spray nozzle 720.

The targeting system 292 may include a success determination subsystem. The success determination subsystem may use post-spray target data gathered by the target data acquisition system to provide feedback to the targeting system 292 regarding the effectiveness of the spray relative to the spray objectives. For example, the target data acquisition system may use the cameras 830 and/or the sensors 806, 812 to measure how much spray was deposited on or within a target's desired contact area. This measure of success may be used to calibrate and adjust certain targeting system 292 calculations for subsequent spray vector inputs and calculations and as inputs to the mission rules and mission planning process. If the spray or a sample of sprays is measured to be not successful within a first predetermined success threshold, then the targeting system 292 may be configured to adjust one or more targeting computations in real-time, or near real-time, to increase the probability of success for the upcoming prioritized targets. If the spray or a sample of sprays is measured to be not successful within a second predetermined success threshold, then these targets that were not successfully sprayed may be flagged by the targeting system 292 to be resubmitted to the target prioritization subsystem for immediate spraying or spraying at a future point in the current mission by the same or a different drone, or be flagged for treatment during a future mission.

According to some aspects, the pest detection AI framework 292 may be able to determine a maturity of the weed. The pest detection AI framework 292 may then prioritize weeds using one or more priority matrices that are approaching seed maturity in order to eliminate 99% of weeds within the field 1600 prior to seed maturity. The AI framework 292 may track identified weeds in order to track a growth progress of the weed in order to determine an optimal treatment time to reduce herbicide use. The tracking of identified weeds may be based at least on phenotype. For example, some small weeds may optimally be destroyed early in order to minimize seeding, while other weeds may be permitted to grow to a size where the weed may absorb more of the herbicide.

Although the aspects described herein demonstrate the detection of pests and

ignore non-pests (e.g., such as crop, bushes, physical objects like a cans, rocks, etc. lying on the field surface), other aspects may detect the crop and treat all non-crop areas as undesirable. In this aspect, some or all non-crop areas may be treated. In the first aspect, the detection of pests may be useful for treatment after seeding where only the pests are treated. In the other aspect, the non- crop areas may be treated in a burn-down phase with a fast-moving vehicle that sprays anything between crop rows indiscriminately, which may be more energy and/or time efficient with a less computational power requirement.

According to the aspects herein, the aerial drone 100 may perform spraying of the weeds 1620, 1622. In other aspects, the aerial drone 202 may instruct a ground-based drone 600 to navigate to the weed positions for eradication.

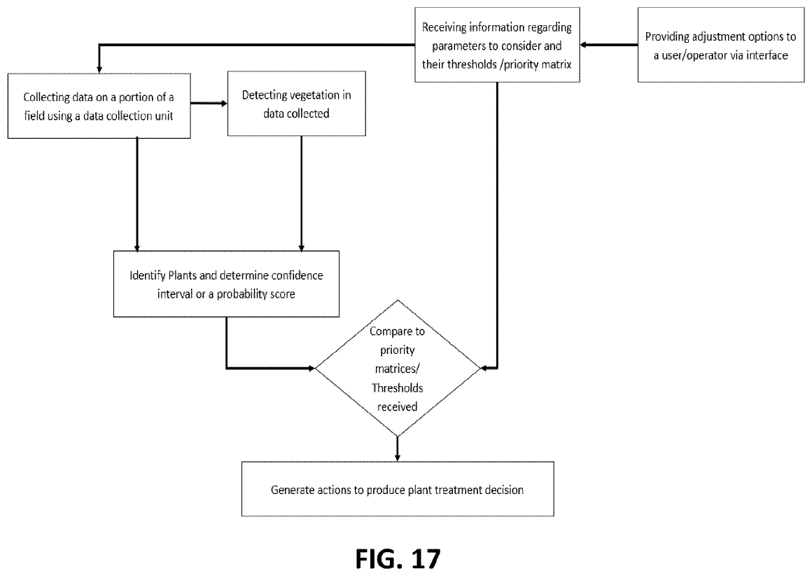

Turning to FIG. 17, an exemplary flowchart of the method used by the present system is illustrated. As shown, the information regarding which parameters to be considered by the system as well as the required thresholds are received at step S1701. This may be in form of a priority matrix and can include other information regarding the parameters, such as their priorities, and/or different scenarios. For example, it can define two parameters A and B to considered but may define the priority order to be different in different seasons and/or humidity level. Furthermore, the priority matrix may be set and/or adjusted by a user as shown in step S1702. In some embodiments, the priority matrix may be predefined for the system. This may include different predefined options among which a user may choose.

At step S1703, the system may collect the information using a data collecting unit. The information collection process may be preset. Alternatively, the information collected may be adjusted based on the parameters that were considered by the system. Therefore, in one example, the system may collect photos of the field and then process and extract the parameters required. In another example, the system may use a sensor along with the camera 256 to collect the information required for performing the analysis.

In step S1705 the system may apply a vegetation detection method to the data collected. In some embodiments, the data collection step 51703 may be adjusted depending on this vegetation detection step and the method used to perform it.

In one embodiment, the vegetation detection process may be used in combination with an assumptive approach, as an alternative or in combination with probability-based approach disclosed herein, for treating the field. In this embodiment, the system may detect vegetation in S1705 and at S1705 only identify if they are in the row or not and apply treatment to any vegetation outside the planted rows.

In step 1705, the system calculates probability scores and/or identifies the plant based on the options chosen in step S1701 using onsite and/or cloud processing. In S1707 system compares the result of probability score/confidence intervals calculation with the priority matrix it has received to make a decision regarding what step to be taken on the field. As described herein, the priority matrix may have a number of parameters and threshold as well as different priority scenarios defined for different circumstances. In step 51709, the system generates actions and perform treatment based on the results of step S1707. This may include treating or not treating the field of a portion of the field and or a vegetation present in the field using a variety of treatment methods as disclosed in this application.

Although the steps of detecting multiple objects, identifying and verifying and prioritizing multiple targets, calculating multiple spray vectors, determining the success of multiple sprays and using the spray success determinations as an input to subsequent spray vector calculations may be shown as single systems or subsystems. One skilled in the art will understand that these systems, subsystems or portions thereof, can be combined, used in a different sequence than shown here, simplified and in some cases omitted to achieve a less complex and less resource intensive design.

Various components, subcomponents and parts can be used to achieve, implement and practice the processes, computations, techniques, steps, means and purposes described herein. The embodiments and inventions contained herein may be practiced in various forms and approaches as selected by one skilled in the art. For example, these processes, computations, techniques, steps, means and purposes described herein may be achieved and implemented in hardware, software, firmware or a combination thereof. The computing components and processes described herein can be distributed across a fixed or mobile network or both at the same time or different times. For example, some processing may be performed in one location using a first processor while other processing may be performed by another processor remote from the first processor. Other components of computer system may be similarly distributed. As such, computer system may be interpreted as a distributed computing system that performs processing in multiple locations. In some instances, computer system may be interpreted as a single computing device.

One skilled in the art may choose hardware implementations for the processing units using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

One skilled in the art may choose implementations including hardware, software, scripting languages, firmware, middleware, microcode, hardware description languages, and/or any combination thereof. Software, firmware, middleware, scripting language, and/or microcode implementations may have the program code or code segments to perform the necessary tasks stored in a machine-readable medium such as a storage medium. A code segment or machine- executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

One skilled in the art may choose implementations including firmware and/or software utilizing modules (e.g., procedures, functions, algorithms, etc.) that perform the processes described herein. Any machine-readable medium tangibly embodying instructions may be used in implementing the processes and methodologies and techniques described herein. For example, software codes may be stored in a memory. Memory may be implemented within a processor or external to a processor. “Memory” as used herein refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory

(RAM), magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, and/or various other storage mediums capable of storing that contain or carry instruction(s) and/or data.

The computer systems described herein may use without limitation one or more general-purpose processors and/or one or more special-purpose processors (such as digital signal processing chips, graphics acceleration processors, video decoders, and/or the like). The computer systems described herein may use and or configure storage devices to implement any appropriate data stores, including without limitation, various file systems, database structures, database control or manipulation or optimization methodologies.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. The foregoing is considered as illustrative only of the principles of the invention. Further, since numerous changes and modifications will readily occur to those skilled in the art, it is not desired to limit the invention to the exact construction and operation shown and 5 described, and accordingly, all such suitable changes or modifications in structure or operation which may be resorted to are intended to fall within the scope of the claimed invention.

1-60 (canceled)

61. A field treatment system comprising:
a vehicle having a data collection unit for collecting data on a portion of a field;
an interface for receiving a first parameter to be considered for treatment of said portion of said field, a first probability score threshold for said first parameter, a second parameter to be considered for treatment of said portion of said field, a second probability score threshold for said second parameter, and a priority matrix defining scenarios under which said first probability score threshold and said second probability score threshold are met to determine treatment;
a calculation unit for calculating a first probability score of said first parameter in said data collected, and a second probability score of said second parameter in said data collected; and, a treatment unit for treating said portion of the field based on said first probability score for said first parameter, said first probability score threshold, said second probability score for said second parameter, said second probability score threshold, and said priority matrix.

62. The system in claim 61, further comprising a vegetation detection module for detecting vegetation in the field.

63. The system in claim 62, wherein said vegetation detection module uses hue, saturation, value (HSV) color index method to detect said vegetation.

64. The system in claim 62, wherein said vegetation detection module uses excess green method to detect said vegetation.

65. The system in claim 62, wherein said vegetation detection module comprises sensor for detecting vegetation.

66. The system in claim 65, wherein said sensor comprises a lidar or a chlorophyll detection sensor.

67. The system in claim 65, wherein said sensor comprises an infrared sensor, or a near-infrared sensor.

68. The system in claim 61, wherein said first and said second parameters comprise plant type and plant stage.

69. The system in claim 61, wherein said first and said second parameters comprise plant location, and plant vitality.

70. The system in claim 61, wherein said first and said second parameters comprise presence of pest in said portion of the field.

71. The system in claim 61, wherein said vehicle is an unmanned aerial vehicle (UAV).

72. The system in claim 61, wherein said vehicle is one or more of a ground sprayer, an unmanned ground robot, and a manned aerial vehicle.

73. The system in claim 61, wherein said treatment unit comprises sprayers for spraying said at least one portion of the field.

74. The system in claim 61, wherein said treatment unit is a UAV.

75. A field treatment system comprising:
a data collection unit for collecting data on a portion of a field;
a treatment unit;
an interface;
a control unit comprising:
a processor; and
a non-transitory computer-readable medium containing instructions that, when executed by the processor, causes the processor to perform:
collecting data on said portion of the field using said data collection unit;
receiving a first parameter to be considered for treatment of said portion of said field and a first probability score threshold for said parameter;
calculating a first probability score of said first parameter related to said portion of the field in said data; and,
receiving one or more secondary parameters to be considered for treatment of said portion of said field and one or more secondary probability score thresholds for said one or more secondary parameters;
calculating one or more secondary probability scores for said one or more secondary parameters related to said portion of the field in said data;
receiving a priority matrix defining scenarios under which said first probability score threshold and said one or more second probability score thresholds are met to determine treatment;
treating said portion of the field based on said first probability score, said one or more secondary probability scores, said first threshold, said one or more secondary thresholds and said priority matrix using said treatment unit.

76. The system as defined in claim 75, wherein the system further comprises a vegetation detection module, and wherein the non-transitory computer-readable medium further contains instructions that cause the processor to perform: applying a vegetation detection process to said collected data.

77. The system in claim 76, wherein said calculating said first probability score in said data collected comprises calculating said first probability score of said first parameter only for detected vegetation using said vegetation detection process.

78. The system in claim 76, wherein said vegetation detection process comprises applying an excess green method to said collected data.

79. The system in claim 76, wherein said detecting vegetation in said field comprises using a sensor comprises using a lidar or a chlorophyll detection sensor to detect said vegetation.

80. The system in claim 79, wherein said detecting vegetation in said field using said sensor comprises using an infrared sensor, or near-infrared sensors to detect said vegetation.

81. The system in claim 75, wherein said treating comprises treating said portion of the field based on said first probability score, said one or more secondary probability scores, said first threshold, said one or more secondary thresholds and said priority matrix using said treatment unit when the first probability score is equal or higher than said first probability score threshold.

82. The system in claim 75, wherein said treating comprises treating said portion of the field based on said first probability score, said one or more secondary probability scores, said first threshold, said one or more secondary thresholds and said priority matrix using said treatment unit when the first probability score is lower than said first probability score threshold.

83. The system in claim 75, wherein said data collection unit is embedded in an unmanned aerial vehicle (UAV).

84. The system in claim 75, wherein said treatment unit is embedded in an UAV.
